(19) United States
(12) Patent Application Publication
(10) Pub. No.: US 2026/0280337 A1
(43) Pub. Date: Sep. 17, 2026

(54) Deploying Facility System On Cloud

(71) Applicant: Oracle International Corporation, Redwood Shores, CA (US)

(72) Inventors: Joshua Horwitz, Centreville, VA (US); Heyang Chen, Newark, CA (US); Zachary Gilburd, Seattle, WA (US)

(73) Assignee: Oracle International Corporation, Redwood Shores, CA (US)

(21) Appl. No.: 19/296,381

(22) Filed: Aug. 11, 2025

Related U.S. Application Data
(60) Provisional application No. 63/771,179, filed on Mar. 13, 2025.

(51) Int. Cl. H02J 13/00; G05B 19/418; H04L 67/10

(52) U.S. Cl. CPC H02J 13/10; G05B 19/41855; H04L 67/10

(57) ABSTRACT

A system that routes a signal indicating a physical condition through a facility network from a controller to a communication channel is disclosed. The system routes the first signal through a cloud network from the communication channel to a supervisory control and data acquisition (SCADA) service. The SCADA service processes the signal to generate a second signal, indicating a control response. The system routes the second signal through the cloud network from the SCADA service to the first communication channel. The system routes the second signal through the facility network from the communication channel to a second controller. The cloud network operates as a separate network from the first facility network.

### INCORPORATION BY REFERENCE; DISCLAIMER

The following application is hereby incorporated by reference: application No. 63/771,179, filed on Mar. 13, 2025, entitled “Deploying Facility System on Cloud”. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates generally to industrial control systems, and more particularly, supervisory control architectures and implementations for monitoring and managing physical environments in industrial and commercial applications.

### BACKGROUND

Industrial and commercial facilities, such as data centers, manufacturing plants, and utility installations, rely on various critical systems, including cooling systems (both liquid and air-based), power distribution systems, and physical security systems. These systems require constant monitoring and rapid response capabilities to maintain operational conditions and prevent failures that could lead to service disruptions or equipment damage.

Supervisory control and data acquisition (SCADA) is a category of industrial control systems that enable remote monitoring and control of industrial processes and infrastructure. Developed in the 1960s, SCADA systems serve as the technological backbone for managing critical infrastructure, including power grids, water treatment facilities, oil and gas pipelines, manufacturing plants, and transportation networks. These systems collect real-time data from sensors and equipment distributed across wide geographical areas, allowing operators to visualize processes, track performance metrics, and implement automated control responses.

Supervisory control and data acquisition (SCADA) systems are typically deployed as on-premise solutions to monitor and control industrial processes and infrastructure. These SCADA implementations require dedicated hardware, significant upfront capital expenditure, and specialized IT personnel for maintenance and operation. Furthermore, traditional SCADA systems often face limitations in scalability, redundancy, and the ability to centrally manage multiple physical environments across different geographic locations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system architecture with cloud-based SCADA services interconnected with facility networks through dedicated communication channels in accordance with one or more embodiments;

FIG. 2 illustrates an example set of operations for processing physical condition signals from facility environments through a cloud-based SCADA service in accordance with one or more embodiments;

FIG. 3 illustrates an overheating detection example that processes physical condition signals from facility environments through a cloud-based SCADA service in accordance with one or more embodiments;

FIG. 4 is a block diagram illustrating one pattern for implementing a cloud infrastructure as a service system according to at least one embodiment;

FIG. 5 is a block diagram illustrating another pattern for implementing a cloud infrastructure as a service system according to at least one embodiment;

FIG. 6 is a block diagram illustrating another pattern for implementing a cloud infrastructure as a service system according to at least one embodiment;

FIG. 7 is a block diagram illustrating another pattern for implementing a cloud infrastructure as a service system according to at least one embodiment;

FIG. 8 is a high-level diagram of a distributed environment showing a virtual or overlay cloud network hosted by a cloud service provider infrastructure according to certain embodiments;

FIG. 9 depicts a simplified architectural diagram of the physical components in the physical network within CI according to certain embodiments;

FIG. 10 depicts a simplified block diagram of a physical network provided by a CI according to certain embodiments;

FIG. 11 depicts a data center including rows of compute racks and network racks, with the network racks implementing a network fabric according to certain embodiments; and

FIG. 12 depicts a block diagram that illustrates a computer system in accordance with one or more embodiments.

### INTRODUCTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The term “cloud computing service” or “cloud service” generally refers to a service that is made available on demand, via scalable cloud infrastructure, typically over the internet or a private network, and managed by an external or in-house cloud provider (CP). The term “cloud infrastructure” (CI) generally refers to hardware and software components that provide computing, storage, and networking resources to deliver cloud services. There are various types or models of cloud services including Software-as-a-Service (SaaS), Platform-as-a-Service (PaaS), Infrastructure-as-a-Service (IaaS), Function-as-a-Service (FaaS), and others.

In a typical IaaS model, a CP provides virtualized and bare metal computing resources like servers, storage, and networking in a CP-operated data center. The CP is responsible for managing and maintaining the CI; the responsibilities span across multiple domains, such as operations, security, scalability, and compliance. Customers access the cloud services over the public Internet. Customers can use the CP CI to build their own customizable virtual or overlay networks and deploy customer resources. In other models, a CP provides similar virtualized and bare metal computing resources but in a customer-operated data center, which may include the customer's own CI. Customers access the CP CI and the customer CI over a private network. The combination of cloud services of the CP and the customer may be referred to as a “hybrid cloud.” In some cases, customers can serve as the CP's partner and sell the CP cloud services to further downstream customers. In yet other models, a first CP provides its virtualized and bare metal computing resources like servers, storage, and networking in the first CP's data center. A second CP provides its virtualized and bare metal computing resources also in the first CP's data center. A dedicated private network connects the CI of the two CPs. The combination of cloud services of the both CPs may be referred to as a “hybrid cloud.” In yet other models, a CP initially provisions CI to a customer, and then hands over all or a subset of the responsibilities associated with managing and maintaining the CI. For example, the customer may be primarily responsible for duties such as provisioning, repair, and maintenance of compute instances, while the CP retains other duties such as network management. Still other models may be used.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD-BASED SCADA SERVICES SYSTEM
3. CLOUD-BASED SCADA SERVICES METHOD
4. CLOUD-BASED SCADA SYSTEM OPERATIONAL FLOW EXAMPLE
5. PRACTICAL APPLICATIONS, ADVANTAGES & IMPROVEMENTS
6. EXAMPLES OF CLOUD INFRASTRUCTURE
7. EXAMPLES OF CLOUD NETWORKS
8. EXAMPLE NETWORK FABRICS
9. HARDWARE OVERVIEW
10. MISCELLANEOUS; EXTENSIONS

### 1. GENERAL OVERVIEW

One or more embodiments implement a cloud-based supervisory control and data acquisition (SCADA) service for monitoring and controlling physical environments across multiple facilities. The cloud-based SCADA service receives signals from facility controllers, indicating physical conditions detected in physical environments, processes those signals to determine appropriate control responses, and transmits control signals back to facility controllers for implementation. Physical conditions monitored by controllers encompass environmental factors related to cooling systems, power distribution systems, or physical security systems within facilities. Controllers generate signals based on sensor data collected from various devices under control within facility environments.

One or more embodiments utilize separate network infrastructures to maintain security while enabling communication between facilities and cloud services. The facility networks operate locally to physical environments with dedicated network fabrics distinct from cloud network infrastructure. Communication channels connect facility networks to cloud networks through specialized interfaces that maintain logical separation between networks while enabling secure bidirectional information flow. These communication channels operate through dedicated peering connections or physical connections established between facility networks and cloud networks, preserving network boundary integrity while permitting necessary data exchange for management purposes. In an embodiment, the communication channels include additional isolation mechanisms, such as firewalls or application-aware gateways.

One or more embodiments support multiple facility environments through a centralized, cloud-based SCADA service. The cloud-based architecture processes signals from various facility networks, enabling consolidated monitoring and control across different physical environments. Control responses generated by SCADA services implement appropriate physical actions within respective facilities through designated controllers. A graphical user interface (GUI) associated with SCADA services presents information from multiple physical environments, enabling operators to monitor conditions across facilities simultaneously. Physical responses implemented through controllers address cooling requirements, power management needs, or physical security concerns depending on detected conditions.

One or more embodiments leverage cloud computing capabilities to enhance SCADA functionality. The SCADA service operates on on-demand, scalable resources within cloud environments, utilizing cloud services for processing and management tasks. Cloud-based SCADA services operate within availability domains or cluster placement groups (CPGs) for enhanced reliability and performance. Programmable logic controllers (PLCs) at facilities communicate with cloud-based SCADA services, maintaining operation continuity across network boundaries. Controllers receiving response signals from SCADA services implement physical changes within environments based on centralized processing decisions.

One or more embodiments described in this Specification and/or recited in the claims may not be included in this General Overview section.

### 2. CLOUD-BASED SCADA SERVICES SYSTEM

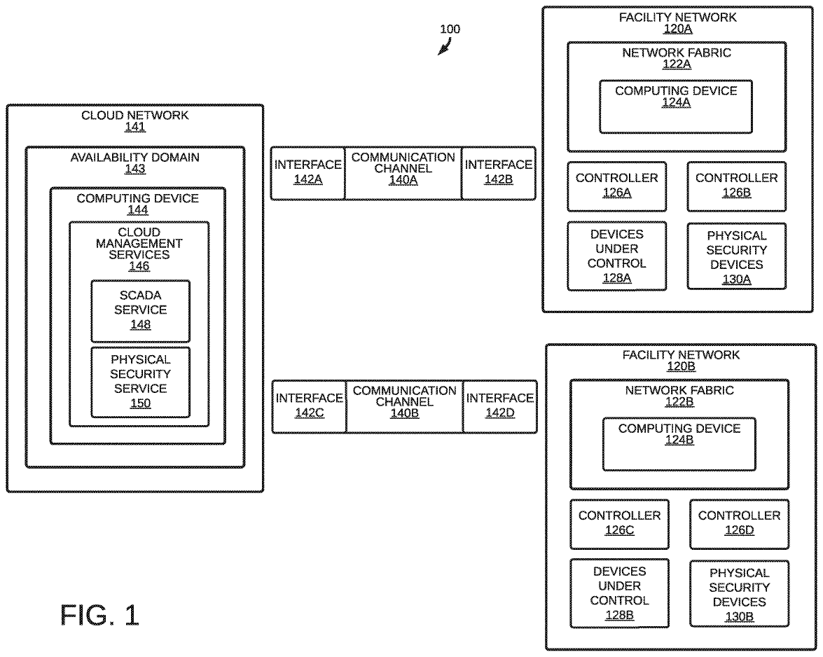

FIG. 1 illustrates a system architecture with cloud-based SCADA services interconnected with facility networks through dedicated communication channels in accordance with one or more embodiments. As illustrated in FIG. 1, system 100 includes facility network 120A, facility network 120B, network fabric 122A, network fabric 122B, computing device 124A, computing device 124B, controller 126A, controller 126B, controller 126C, controller 126D, devices under control 128A, devices under control 128B, physical security devices 130A, physical security devices 130B, communication channel 140A, communication channel 140B, cloud network 141, interface 142A, interface 142B, interface 142C, interface 142D, availability domain 143, computing device 144, cloud management services 146, SCADA service 148, and physical security service 150.

In an embodiment, facility network 120A functions as a dedicated network for controlling physical infrastructure components within a physical environment. Facility network 120A operates separately from other networks in a data center environment, providing isolation between facility management traffic and customer workload traffic. Facility network 120A connects to cloud network 141 through communication channel 140A while maintaining logical separation between networks.

In an embodiment, network fabric 122A provides connectivity for components within facility network 120A. Network fabric 122A includes switches, routers, and associated hardware, forming a complete networking infrastructure. Network fabric 122A maintains separation from customer-facing networks while enabling internal facility communications. Physical networks are associated with separate network fabrics. Network fabric 122A provides dedicated connectivity paths between controllers 126A, 126B, and devices under control 128A.

In an embodiment, computing device 124A hosts management software for facility network 120A components. Computing device 124A executes monitoring applications, configuration utilities, and local management interfaces for facility personnel. Computing device 124A supports direct physical connections to controllers 126A and 126B for configuration and troubleshooting operations. Computing device 124A facilitates local visibility into facility operations when cloud-based SCADA service 148 becomes unavailable.

In an embodiment, controllers, such as controller 126A and controller 126B, are PLCs that monitor and control physical equipment in a physical environment such as a data center. Controllers, such as controller 126A and controller 126B, connect directly to devices under control 128A, such as valves, uninterruptible power supplies (UPS), and other equipment throughout a facility. Controllers, such as controller 126A and controller 126B, execute predetermined failsafe procedures during communication loss with SCADA service 148, maintaining critical system operations based on last known good configurations. Controllers, such as controller 126A and controller 126B, transmit signals indicating physical conditions to SCADA service 148 and receive control response signals from SCADA service 148.

In an embodiment, devices under control 128A include mechanical and electrical equipment necessary for data center operation. Exemplary devices under control 128A include chillers, cooling towers, electrical distribution equipment, and environmental sensors monitored by controllers, such as controller 126A and controller 126B. Devices under control 128A receive control signals from SCADA service 148 during normal operation. Devices under control 128A maintain basic functionality during SCADA communication interruptions through local controller 126A operation. Devices under control 128A generate status signals forwarded through controllers, such as controller 126A and controller 126B, to SCADA service 148 for centralized monitoring.

In an embodiment, physical security devices 130A monitor and control physical access within facility network 120A environment. Physical security devices 130A include badge readers controlling door access, cameras recording facility areas, and sensors detecting unauthorized entry attempts. Physical security devices 130A store data and operate locally while reporting to centralized physical security service 150. In one embodiment, physical security devices 130A operate on separate virtual local area networks from operational technology devices for security purposes.

In an embodiment, facility network 120B functions similarly to facility network 120A but serves a separate distinct physical environment. Facility network 120B connects to cloud network 141 through communication channel 140B, enabling coordinated management across multiple locations. Facility network 120B maintains operational independence from facility network 120A while sharing centralized management through cloud network 141. Facility network 120B includes network fabric, computing device 124B, controller 126C, and controller 126D, devices under control and physical security devices 130B that operate similarly to the corresponding elements in facility network 120A.

In an embodiment, cloud network 141 provides centralized processing resources for multiple facility networks while maintaining physical separation from facility equipment. Cloud network 141 hosts SCADA service 148 and physical security service 150 on virtualized infrastructure with enhanced reliability through automated backups and high availability architecture. Cloud network 141 connects to facility network 120A through communication channel 140A and to facility network 120B through communication channel 140B.

In an embodiment, availability domain 143 provides compute, storage, and networking resources for SCADA service 148 and physical security service 150. Availability domain 143 is a physically isolated, independent data center within a region that provides redundancy and high-availability for cloud resources. Availability domains have their own power, cooling, and networking infrastructure to prevent single points of failure, allowing applications to continue running even if one domain experiences issues. Cloud providers typically recommend distributing critical workloads across multiple availability domains to ensure business continuity during outages or maintenance. By deploying resources across different availability domains, organizations have resilient architectures that maintain application availability despite infrastructure failures in any single location. Availability domain 143 operates as a semi-autonomous cell within cloud network 141, maintaining local service availability even if connection to parent regions becomes unavailable. Availability domain 143 provides latency guarantees, ensuring responsive control despite physical distance separation from facility networks. Availability domain 143 hosts multiple cloud management services 146 that support facility management functions. Availability domain 143 connects to facility networks through dedicated interfaces 142A and 142C.

In an embodiment, a cluster placement group (CPG) within availability domain 143 is a logical grouping of cloud resources, like compute instances and block volumes, that are physically positioned close together within a single availability domain to ensure low network latency between them, essentially placing the related resources in close proximity for high-performance networking needs. CPGs are designed for applications that require extremely low latency communication between multiple instances, like high-performance computing clusters or distributed databases. In an example, cloud management services 146, SCADA service 148, and physical security service 150 are placed in a single CPG.

In an embodiment, computing device 144 hosts virtualized services within cloud network 141 and availability domain 143. Computing device 144 executes SCADA service 148, physical security service 150, and cloud management services 146 as virtual machines or containerized applications. Computing device 144 leverages virtualization technology for automated scaling and hardware independence. Computing device 144 benefits from cloud infrastructure features, like automatic failover, hardware maintenance services, and triple-replicated storage. Computing device 144 provides greater computational resources than traditional on-premise deployments, enabling sophisticated coordination algorithms.

In an embodiment, cloud management services 146 includes SCADA service 148 and physical security service 150. Cloud management services 146 include virtualization platforms, storage systems, network management, and security services required for cloud operations. Cloud management services 146 automate infrastructure management tasks, including backups, scaling, and recovery operations. Cloud management services 146 implement security features that protect facility management systems from unauthorized access. Cloud management services 146 enable consistent operational procedures across various deployment models through standardized interfaces.

In an embodiment, SCADA service 148 provides higher-level monitoring, control, and data acquisition for facility operations in cloud network 141. SCADA service 148 collects data from controllers 126A and 126B in facility network 120A and controllers 126C and 126D in facility network 120B. SCADA service 148 stores historical information, provides user interfaces, generates alarms, and facilitates communication between otherwise isolated controllers. In an example, SCADA service 148 functions as a control plane, processing signals that indicate physical conditions from multiple facility networks and generating appropriate control responses. SCADA service 148 benefits from cloud storage scalability for historian functionality. SCADA service 148 leverages cloud computational resources for sophisticated coordination algorithms that control multiple equipment units.

In an embodiment, SCADA service 148 executes real-time data processing algorithms that transform raw sensor measurements into standardized control commands through mathematical calculations and logical operations. Signal processing includes digital filtering operations to remove noise from sensor readings, averaging calculations performed over specified time windows, and threshold comparison operations that trigger automated responses.

In one embodiment, controllers 126A-D act as low-level PLCs that maintain critical real-time control functions independent of cloud connectivity. Controllers 126A-D execute deterministic control loops with millisecond-level responsiveness to manage physical processes, implement safety interlocks, and maintain essential operations even during network outages. In one example, SCADA service 148 establishes a hierarchical architecture where edge gateways or remote terminal units (RTUs) mediate communication between the isolated PLC networks and the cloud environment, implementing protocol translation, data buffering, and security measures, such as unidirectional data flows and demilitarized zones (DMZs). This architecture preserves operational integrity while enabling the cloud-based SCADA system to perform analytics, cross-facility improvement, and enterprise-level integration without compromising the autonomous functionality of the plant-floor automation layer. Data synchronization occurs on scheduled intervals or event-triggered basis, allowing the cloud SCADA to maintain comprehensive situational awareness while respecting the independence and resilience requirements of critical industrial control systems.

In an embodiment, physical security service 150 monitors and manages security systems across multiple facility networks from cloud network 141. Physical security service 150 processes access control events, manages video recording from security cameras, and generates alerts for security incidents. Physical security service 150 maintains records of physical access for compliance and auditing purposes. Physical security service 150 integrates with SCADA service 148 for comprehensive facility management while maintaining functional separation. Physical security service 150 operates on cloud infrastructure, providing enhanced reliability and data protection compared to traditional security system deployments.

In an embodiment, communication channel 140A establishes a dedicated private connection between facility network 120A and cloud network 141 through a dedicated peering connection and/or a dedicated physical connection. Similarly, communication channel 140B establishes a dedicated private connection between facility network 120B and cloud network 141 through a dedicated peering connection and/or a dedicated physical connection. In one example, communication channels 140A and 140B are private network communication channels such as Oracle's FastConnect technology. Communication channels 140A and 140B provide secure bidirectional communication while maintaining logical separation between networks. Communication channels 140A and 140B prevent unauthorized communication, allowing specifically permitted traffic between facility network 120A or facility network 120B and cloud network 141. Communication channels 140A and 140B provide required performance characteristics for time-sensitive control functions despite physical separation. Communication channels 140A and 140B operate independently from customer-facing management networks, creating separation between facility operations and customer systems. In an embodiment, communication channels 140A and 140B include additional isolation mechanisms, such as firewalls or application-aware gateways.

In an embodiment, interface 142A provides a connection point between cloud network 141 and communication channel 140A. Interface 142A implements security controls that restrict traffic types and communication patterns permitted between networks. Interface 142A monitors communication health, reporting connectivity issues to cloud management services 146. Interface 142A handles protocol conversions between facility network 120A and cloud network 141 when required. Interface 142A maintains separation between facility management traffic and customer-facing management networks.

In an embodiment, interface 142B provides a connection point between communication channel 140A and facility network 120A. Interface 142B implements security controls matching interface 142A for bidirectional communication protection. Interface 142B routes signals from controller 126A to SCADA service 148 and routes control responses from SCADA service 148 to controller 126A. Interface 142B monitors local connectivity health, implementing failover procedures during communication interruptions. Interface 142B provides a physical demarcation point between communication channel 140A and facility network 120A infrastructure. Interfaces 142C and 142D operate similarly as interfaces 142A and 142B but with respect to facility network 120B.

In an embodiment, separate networks are distinct networks that maintain logical and/or physical separation from each other, preventing unauthorized direct communication while enabling controlled communication through designated interfaces. Each separate network operates with its own network fabric and addressing scheme. In FIG. 1, facility network 120A, facility network 120B, and cloud network 141 are separate networks. For example, traffic from facility network 120A cannot directly reach devices within cloud network 141 except through designated communication channel 140A and interfaces 142A and 142B. The interfaces implement security controls that restrict traffic types and communication patterns permitted between the separate networks, ensuring that only specifically authorized communication occurs between networks while maintaining logical separation.

In an embodiment, a facility network operates as a dedicated network infrastructure local to a physical environment, such as a data center or industrial facility, while a cloud network operates as a distributed network infrastructure providing virtualized computing resources. The facility network maintains direct physical connections to controllers, sensors, and devices under control within the physical environment through dedicated network fabric, enabling real-time monitoring and control of mechanical systems, electrical systems, and physical security systems. In contrast, the cloud network hosts virtualized services such as SCADA service 148 and cloud management services 146 on scalable, on-demand computing resources within availability domains or cluster placement groups.

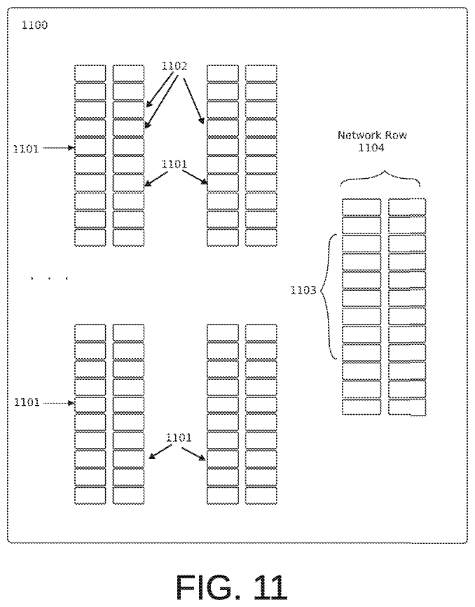

In one or more embodiments, availability domain 143, cloud management services 146, SCADA service 148, and physical security service 150 refer to hardware and/or software configured to perform operations described herein for cloud-based SCADA services. Examples of operations for cloud-based SCADA services are described below with reference to FIG. 11.

In accordance with an embodiment, availability domain 143, cloud management services 146, SCADA service 148, and physical security service 150 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. CLOUD-BASED SCADA SERVICES METHOD

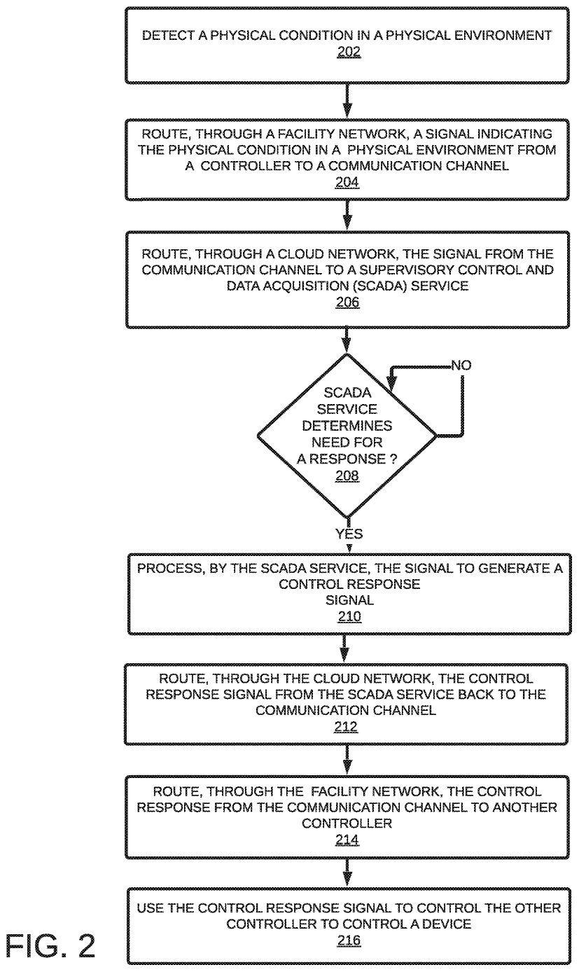

FIG. 2 illustrates an example set of operations for processing physical condition signals from facility environments through a cloud-based SCADA service in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, a facility management architecture includes a facility network that includes PLCs for monitoring and controlling physical equipment in a data center. The facility network operates as a separate physical network from other networks in the data center environment. The PLCs connect directly to devices, such as valves, and other smart equipment throughout the facility, providing localized control functions based on simple conditional logic. The facility network includes multiple VLANs that support different functions, such as office Wi-Fi, device networking, and security systems with badge readers and cameras.

In an embodiment, the system detects a physical condition present in a physical environment (Operation 202). The system incorporates PLCs connected to sensors deployed throughout the physical environment to monitor various parameters related to facility operations. The sensors transmit readings to connected controllers whenever the physical parameters change beyond predetermined thresholds. The sensors monitor critical infrastructure components, including chillers, electrical equipment, liquid cooling systems, air-cooling systems, power distribution systems, and physical security mechanisms. The detection occurs in real-time with the sensor devices designed to continue functioning, even during network disruptions, to maintain critical system operations based on last known good configurations.

In an embodiment, the controllers involved in facility management are PLCs. These PLCs generate signals based on physical conditions detected by sensors. In one example, the detected physical conditions in a facility are related to a component of a liquid cooling system, a component of an air-cooling system, a component of a power distribution system, or a component of a physical security system.

In an embodiment, the system routes a signal through a facility network, indicating the detected physical condition from a controller to a communication channel (Operation 204). The facility network exists as a separate physical network from other networks within the data center environment, including customer workload networks, front-end networks, back-end networks, and management networks. The controller connects directly to physical equipment through hardwired connections within the facility, providing localized control functions based on simple conditional logic. The signal includes encoded information about the nature of the detected condition. As discussed above, the facility network maintains local communication capabilities even during disruptions to external network connectivity, ensuring continuous basic operation even during SCADA system unavailability.

In an embodiment, the system routes the signal through a cloud network from the communication channel to an SCADA service (Operation 206). The cloud network operates as a distinct network from the facility network with separate physical infrastructure connected via a fast connect bridge. The communication channel establishes a dedicated private connection between the facility network and cloud network, enabling secure bidirectional communication while maintaining logical separation between networks. The connection implements security controls at both endpoints to restrict traffic types and communication patterns, preventing unauthorized communication between networks. The routing mechanism ensures consistent performance characteristics regardless of physical distance between control systems and monitored equipment, accommodating varying distances while maintaining required responsiveness through localized CPGs.

In an embodiment, the SCADA service operates on on-demand, scalable resources in the cloud environment. The SCADA service executes within containerized microservices deployed using Kubernetes orchestration, with microservices implementing specific functions, such as data acquisition and alarm processing. The SCADA service operates on one or more cloud services in the cloud environment and operates in at least one of an availability domain or a cluster placement group of the cloud environment. Cluster placement groups implement rack-aware scheduling to co-locate related services within the same physical rack or adjacent racks, reducing inter-service latency. This architecture leverages greater computational resources than traditional on-premise deployments while maintaining performance and security requirements. The CPGs provide locally available compute, storage, and networking resources within the cloud environment, maintaining local service availability even if a connection to parent regions becomes unavailable.

In an embodiment, the SCADA service functions as a control plane for the facility, collecting data from PLCs, storing historical information, providing user interfaces, generating alarms, and facilitating communication between otherwise isolated controllers. The SCADA service operates separately from the facility network through a dedicated private connection, with the facility network remaining on mechanical infrastructure while SCADA moves to the cloud environment. Historian functionality within the SCADA system records long-term operational data from connected facility systems.

In an embodiment, the system determines if the SCADA service should generate a response based on the received signal (Operation 208). If the SCADA service should not generate a response based on the received signal in operation 208, then the SCADA system waits. If the SCADA service should generate a response based on the received signal in operation 208, then the system proceeds to operation 210.

In an embodiment, the system processes the signal through the SCADA service to generate a control response signal when a response need exists (Operation 210). The processing occurs within CPGs that provide locally available compute, storage, and networking resources within the cloud environment, maintaining local service availability even if a connection to parent regions becomes unavailable. In an example, the control response signal includes specific instructions for physical equipment to execute remedial actions. The generation process accounts for dependencies between different facility systems, including building management systems (BMS) and electrical power management systems (EPMS) to prevent cascading failures.

In an embodiment, CPGs within the cloud environment provide locally available compute, storage, and networking resources for the SCADA system. Cluster placement groups operate as semi-autonomous cells within the broader cloud architecture, maintaining local service availability even if connection to parent regions becomes unavailable. The CPGs provide latency guarantees, ensuring responsive control and monitoring despite physical distance separation from the facility network. Multiple CPGs deploy across different buildings in a campus environment, creating independent operational domains. In one example, buildings maintain their own CPG with independent SCADA and security systems, allowing a single operator to monitor multiple buildings through the cloud backbone network while maintaining local autonomy. The system additionally integrates physical security components, including video management systems, badge scanners, cameras, and intrusion detection systems within the same cloud infrastructure, providing centralized monitoring capabilities across multiple buildings.

In an embodiment, data center chillers require coordinated operation to maintain cooling efficiency across multiple units. The cloud-based SCADA system enables coordination algorithms that leverage greater computational resources than traditional on-premise deployments. The chiller coordination flows through the SCADA system as an event bus, allowing individual units to work together despite having no direct communication between controllers. When SCADA communication becomes unavailable, the chillers operate based on predetermined parameters or the last known condition, maintaining basic local control through the facility network.

In an embodiment, the system routes the control response signal through the cloud network from the SCADA service back to the communication channel (Operation 212). The cloud network maintains the same dedicated private connection used for the incoming signal to return the control response, avoiding reliance on general internet connectivity for critical control system communication. The routing occurs through predefined secure pathways designed to prevent unauthorized access or modification of control signals. The system prioritizes control response traffic to ensure timely delivery even during periods of network congestion, maintaining connectivity between SCADA instances during normal operations while preserving isolation during failure scenarios.

In an embodiment, cloud backbone networking connects multiple running SCADA instances. The cloud backbone enables centralized monitoring and management across physically separated networks. Operations personnel monitor multiple buildings from a single location through the interconnected SCADA systems. The cloud backbone maintains connectivity between SCADA instances during normal operations while preserving isolation during failure scenarios. Buildings maintain operational independence through local clustering despite using the cloud backbone for centralized operations.

In an embodiment, multi-building architectures deploy independent SCADA instances in CPGs for the buildings. The cloud backbone network connects these separate SCADA instances, enabling coordinated operations while maintaining physical isolation. The multi-building implementation centralizes operations staffing requirements, allowing fewer personnel to monitor multiple facilities. The multi-building architecture maintains resilience through physical separation while enabling logical centralization through cloud interconnectivity. Personnel access building-specific SCADA interfaces through standard web browsers connected to the cloud backbone network, eliminating requirements for specialized monitoring equipment at the locations.

In an embodiment, the system routes the control response signal through the facility network from the communication channel to another controller (Operation 214). The facility network delivers the control response to the appropriate programmable logic controller based on addressing information included within the signal. The destination controller enables cross-system coordination of responses across mechanical systems, electrical systems, and security systems. The facility network maintains physical separation between different operational domains while enabling logical integration through controlled connection points. The routing architecture creates boundaries between functional areas while enabling coordinated operations through well-defined integration points, maintaining physical separation between different operational domains.

In an embodiment, a dedicated private connection links between the facility network and the cloud network where the SCADA system operates. The dedicated private connection enables secure bidirectional communication while maintaining logical separation between the networks. The dedicated private connection prevents unauthorized communication between networks, allowing specifically permitted traffic to pass between the facility network and the SCADA system. Multiple dedicated private connections connect different facility networks in separate buildings to their respective cloud environments.

In an embodiment, the system uses the control response signal to control another controller to control a physical device (Operation 216). The receiving controller executes the instructions included within the control response signal to modify the operation of connected physical equipment, including valves, chillers, and other smart equipment throughout the facility. The controller applies changes to equipment parameters, including valve positions, power levels, or security mechanisms, based on predetermined parameters. The physical response addresses the original detected condition to restore normal operational status while maintaining basic functionality during SCADA communication interruptions through local programmable logic controller operation. The architecture enables sophisticated user interfaces unavailable in traditional deployments, providing enhanced visualization capabilities, analytical tools, and reporting functions beyond typical on-premise capabilities. In one embodiment, the physical response is a cooling, power, or physical security response.

In an embodiment, controller logic remains distributed throughout the facility on PLCs while higher-level coordination moves to the cloud-based SCADA system. The PLCs maintain direct physical connections to monitored equipment, ensuring continuous basic operation even during SCADA system unavailability. The PLCs execute predetermined failsafe procedures during communication loss with the SCADA system, maintaining critical system operations based on last known good configurations. Multiple PLCs operate throughout the building, with supervisory controllers managing individual data halls independently from central SCADA systems.

In an embodiment, operational benefits of cloud-based SCADA implementation include user interfaces unavailable in traditional deployments. The cloud environment supports enhanced visualization capabilities, analytical tools, and reporting functions beyond typical on-premise capabilities. The architecture leverages existing cloud development infrastructure to improve facility management interfaces without requiring specialized development environments. The user experience improvements lead to better operational awareness and faster issue identification compared to traditional facility management systems.

In an embodiment, a GUI associated with the SCADA service presents information associated with signals that indicate physical conditions in multiple physical environments. This unified interface enables operations personnel to monitor multiple buildings or environments from a single location through the interconnected SCADA systems, allowing centralized management while maintaining physical system separation. The GUI presents both real-time condition information and historical trends derived from the historian functionality.

In an embodiment, the cloud-based SCADA architecture scales to manage multiple facility networks across different physical locations. When implemented across multiple buildings, the system deploys independent SCADA instances in dedicated CPGs for the facilities while maintaining a unified control interface. The cloud backbone network connects these separate SCADA instances, enabling coordinated operations while preserving physical isolation between facilities. This architecture centralizes operations staffing requirements, allowing fewer personnel to monitor multiple facilities simultaneously through a single GUI. Facility networks maintain operational independence through local controllers that execute predetermined failsafe procedures during communication loss, while the cloud-based SCADA service provides coordination across connected facilities.

In an embodiment, architecture combines mechanical systems control with enhanced cloud capabilities in environments where a single organization manages both infrastructure components. The architecture creates particular benefits in owner-operated or leased facilities where separate operational domains become unnecessary. The architecture reduces overall operational complexity by standardizing on cloud-based management across both IT and facility domains, applying consistent management practices to previously disparate systems.

### 4. CLOUD-BASED SCADA SYSTEM OPERATIONAL FLOW EXAMPLE

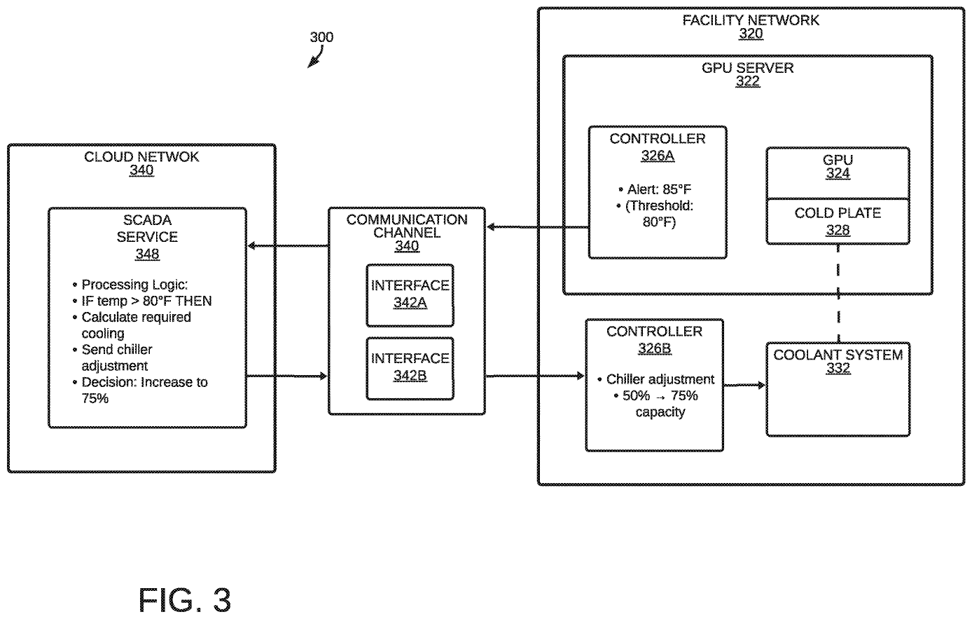

FIG. 3 illustrates an overheating detection example that processes physical condition signals from facility environments through a cloud-based SCADA service in accordance with one or more embodiments. The operational flow depicted in FIG. 3 demonstrates a concrete implementation of cloud-based SCADA service 348 managing cooling system responses for graphics processing unit (GPU) thermal conditions within facility network 320. The system 300 illustrates bidirectional communication between facility network 320 and cloud network 340 through communication channel 341 with dedicated interfaces 342A and 342B.

In an embodiment, GPU server 322 includes GPU 324 connected to cold plate 328 for thermal management within facility network 320. Cold plate 328 transfers heat from GPU 324 to coolant system 332 through direct thermal contact using thermally conductive metal interfaces with embedded thermistors that exhibit variable electrical resistance proportional to temperature changes. Temperature sensors integrated within cold plate 328 monitor thermal conditions and transmit temperature readings to controller 326A through electronic connections via analog-to-digital conversion circuits that sample resistance values at regular intervals and convert the analog voltage signals into digital temperature data packets.

In the example, controller 326A determines that temperature sensors report GPU 324 temperature of 85 degrees Fahrenheit, exceeding a safety threshold of 80 degrees Fahrenheit. Controller 326A generates a signal including temperature data, component identification information, and timestamp data indicating the detected thermal condition. The signal includes encoded parameters that specify the measured temperature value, location identifier for GPU 324, and alert status indicators, marking this as a critical temperature alert.

In an embodiment, controller 326A routes the signal through facility network 320 to interface 342A of communication channel 341. Facility network 320 maintains dedicated communication pathways between controller 326A and interface 342A using network fabric infrastructure separate from customer workload networks.

In an embodiment, communication channel 341 transmits the signal from interface 342A to interface 342B through a dedicated connection between facility network 320 and cloud network 340. Communication channel 341 implements security protocols and maintains logical separation between networks while enabling bidirectional data flow. Interface 342B receives the signal and routes the signal through cloud network 340 to SCADA service 348.

In an embodiment, SCADA service 348 within cloud network 340 receives the signal and executes processing logic to determine cooling system response requirements. SCADA service 348 analyzes the temperature data against predetermined threshold values using the decision logic: “IF temperature >80° F., THEN calculate required cooling capacity” and calculates required cooling capacity adjustments. The processing logic evaluates current coolant system 332 operating parameters and determines that chiller capacity requires adjustment from 50 percent to 75 percent to maintain GPU 324 temperature below 80 degrees Fahrenheit.

In an embodiment, SCADA service 348 generates a control response signal that includes specific instructions for coolant system 332 operation. The control response signal includes target capacity settings, adjustment timing parameters, and equipment identification data for controller 326B. SCADA service 348 routes the control response signal through cloud network 340 back to interface 342B of communication channel 341.

In an embodiment, interface 342B receives the control response signal and transmits the signal across communication channel 341 to interface 342A within facility network 320. Interface 342A performs protocol conversion and routes the control response signal through facility network 320 to controller 326B connected to coolant system 332.

In an embodiment, controller 326B receives the control response signal and executes the cooling capacity adjustment instructions. Controller 326B sends control commands to coolant system 332 to increase chiller operation from 50 percent capacity to 75 percent capacity. Coolant system 332 implements the capacity increase, resulting in increased coolant flow rate and enhanced heat removal from cold plate 328, effectively addressing the overheating condition.

In an embodiment, the increased coolant flow through cold plate 328 removes additional thermal energy from GPU 324, reducing GPU 324 temperature below the 80 degrees Fahrenheit threshold, bringing the system back to safe operating conditions. Controller 326A continues monitoring temperature conditions and transmits updated temperature readings to SCADA service 348 through the same communication pathway, enabling continuous feedback control of the cooling system to maintain optimal GPU performance and prevent thermal damage. This operational flow demonstrates centralized processing capabilities, where SCADA service 348 coordinates cooling responses across multiple facility components while maintaining network separation between facility network 320 and cloud network 340. The system enables thermal management functions that execute within cloud network 340 while preserving local controller autonomy for critical safety functions within facility network 320.

### 5. PRACTICAL APPLICATIONS, ADVANTAGES & IMPROVEMENTS

One or more embodiments provide significant technical improvements in SCADA systems. The system provides technical improvements to computer networks by establishing segregated yet interconnected network architecture between local facility networks and cloud infrastructure. Such architecture eliminates traditional bottlenecks encountered in conventional unified networks when processing high volumes of sensor data. The separation of facility networks from cloud networks reduces vulnerability to cascading failures and cyber-attacks by limiting potential attack vectors to discrete segments rather than exposing entire infrastructure. Processing capabilities at the SCADA service level enhance response time for critical physical environment conditions without requiring extensive computing resources at local controllers. Network traffic management improves through targeted signal routing that sends necessary data across network boundaries. The system architecture scales effectively across multiple physical environments without requiring redesign of existing facility networks or cloud infrastructure. Technical performance benefits manifest in reduced latency for time-sensitive control responses and enhanced throughput for environments, generating substantial monitoring data.

### 6. EXAMPLES OF CLOUD INFRASTRUCTURE

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>.[REGION][.FUTURE USE].<UNIQUE ID>
where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

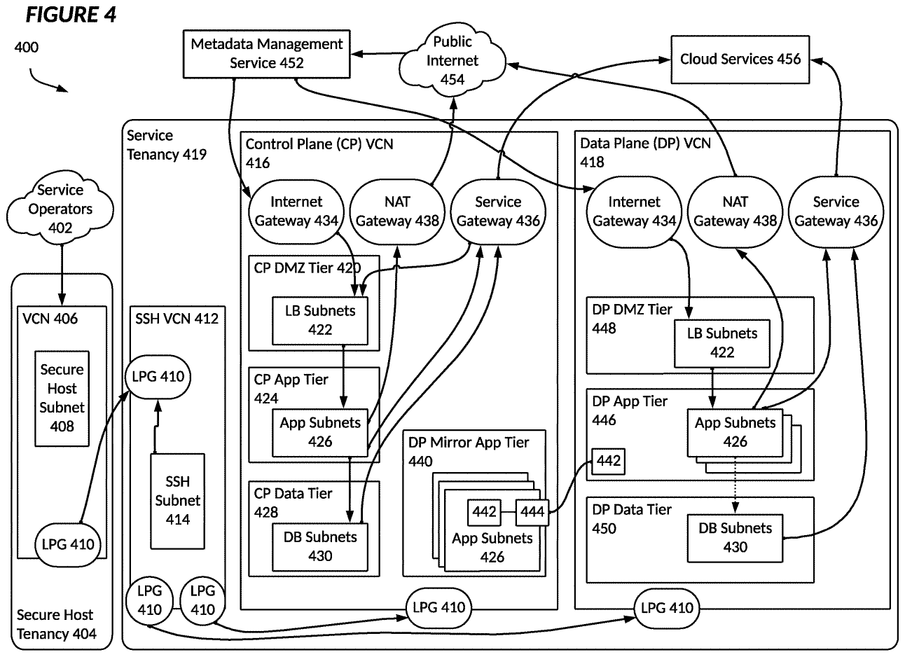

FIG. 4 is a block diagram illustrating an example pattern of an IaaS architecture 400 according to at least one embodiment. Service operators 402 can be communicatively coupled to a secure host tenancy 404 that can include a virtual cloud network (VCN) 406 and a secure host subnet 408. In some examples, the service operators 402 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 6, Palm OS, and the like, and be Internet, e-mail, short message service (SMS), Blackberry®, or other communication protocol enabled. Alternatively, the client computing devices can be general purpose personal computers, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 406 and/or the Internet.

The VCN 406 can include a local peering gateway (LPG) 410 that can be communicatively coupled to a secure shell (SSH) VCN 412 via an LPG 410 implemented in the SSH VCN 412. The SSH VCN 412 can include an SSH subnet 414, and the SSH VCN 412 can be communicatively coupled to a control plane VCN 416 via the LPG 410 implemented in the control plane VCN 416. Also, the SSH VCN 412 can be communicatively coupled to a data plane VCN 418 via an LPG 410. The control plane VCN 416 and the data plane VCN 418 can be implemented in a service tenancy 419 that can be owned and/or operated by the IaaS provider.

The control plane VCN 416 can include a control plane demilitarized zone (DMZ) tier 420 that acts as a perimeter network (e.g., portions of a corporate network between the corporate intranet and external networks). The DMZ-based servers may have restricted responsibilities and help keep breaches contained. Additionally, the DMZ tier 420 can include one or more load balancer (LB) subnet(s) 422, a control plane app tier 424 that can include app subnet(s) 426, a control plane data tier 428 that can include database (DB) subnet(s) 430 (e.g., frontend DB subnet(s) and/or backend DB subnet(s)). The LB subnet(s) 422 in the control plane DMZ tier 420 can be communicatively coupled to the app subnet(s) 426 in the control plane app tier 424 and an Internet gateway 434 that can be implemented in the control plane VCN 416. The app subnet(s) 426 can be communicatively coupled to the DB subnet(s) 430 implemented in the control plane data tier 428 and a service gateway 436 and a network address translation (NAT) gateway 438. The control plane VCN 416 can include the service gateway 436 and the NAT gateway 438.

The control plane VCN 416 can include a data plane mirror app tier 440 that can include app subnet(s) 426. The app subnet(s) 426 implemented in the data plane mirror app tier 440 can include a virtual network interface controller (VNIC) 442 that can execute a compute instance 444. The compute instance 444 can communicatively couple the app subnet(s) 426 of the data plane mirror app tier 440 to app subnet(s) 426 that can be implemented in a data plane app tier 446.

The data plane VCN 418 can include the data plane app tier 446, a data plane DMZ tier 448, and a data plane data tier 450. The data plane DMZ tier 448 can include LB subnet(s) 422 that can be communicatively coupled to the app subnet(s) 426 of the data plane app tier 446 and the Internet gateway 434 of the data plane VCN 418. The app subnet(s) 426 can be communicatively coupled to the service gateway 436 of the data plane VCN 418 and the NAT gateway 438 of the data plane VCN 418. The data plane data tier 450 can also include the DB subnet(s) 430 that can be communicatively coupled to the app subnet(s) 426 of the data plane app tier 446.

The Internet gateway 434 of the control plane VCN 416 and of the data plane VCN 418 can be communicatively coupled to a metadata management service 452 that can be communicatively coupled to public Internet 454. Public Internet 454 can be communicatively coupled to the NAT gateway 438 of the control plane VCN 416 and of the data plane VCN 418. The service gateway 436 of the control plane VCN 416 and of the data plane VCN 418 can be communicatively couple to cloud services 456.

In some examples, the service gateway 436 of the control plane VCN 416 or of the data plane VCN 418 can make application programming interface (API) calls to cloud services 456 without going through public Internet 454. The API calls to cloud services 456 from the service gateway 436 can be one-way; the service gateway 436 can make API calls to cloud services 456, and cloud services 456 can send requested data to the service gateway 436. However, cloud services 456 may not initiate API calls to the service gateway 436.

In some examples, the secure host tenancy 404 can be directly connected to the service tenancy 419. The service tenancy 419 may otherwise be isolated. The secure host subnet 408 can communicate with the SSH subnet 414 through an LPG 410 that may enable two-way communication over an otherwise isolated system. Connecting the secure host subnet 408 to the SSH subnet 414 may give the secure host subnet 408 access to other entities within the service tenancy 419.

The control plane VCN 416 may allow users of the service tenancy 419 to set up or otherwise provision resources. Resources provisioned in the control plane VCN 416 may be deployed or otherwise used in the data plane VCN 418. In some examples, the control plane VCN 416 can be isolated from the data plane VCN 418, and the data plane mirror app tier 440 of the control plane VCN 416 can communicate with the data plane app tier 446 of the data plane VCN 418 via VNICs 442 that can be implemented in the data plane mirror app tier 440 and the data plane app tier 446.

In some examples, users or customers, of the system, can make requests, for example create, read, update, or delete (CRUD) operations, through public Internet 454 that can communicate the requests to the metadata management service 452. The metadata management service 452 can communicate the request to the control plane VCN 416 through the Internet gateway 434. The request can be received by the LB subnet(s) 422 implemented in the control plane DMZ tier 420. The LB subnet(s) 422 may determine that the request is valid, and in response, the LB subnet(s) 422 can transmit the request to app subnet(s) 426 implemented in the control plane app tier 424. If the request is validated and requires a call to public Internet 454, the call to public Internet 454 may be transmitted to the NAT gateway 438 that can make the call to public Internet 454. Metadata to be stored by the request can be stored in the DB subnet(s) 430.

In some examples, the data plane mirror app tier 440 can facilitate direct communication between the control plane VCN 416 and the data plane VCN 418. For example, changes, updates, or other suitable modifications to a configuration may need to be applied to the resources implemented in the data plane VCN 418. Via a VNIC 442, the control plane VCN 416 can directly communicate with, and can thereby execute the changes, updates, or other suitable modifications to configuration to, resources implemented in the data plane VCN 418.

In some embodiments, the control plane VCN 416 and the data plane VCN 418 can be implemented in the service tenancy 419. In this case, the user, or the customer, of the system may not own or operate either the control plane VCN 416 or the data plane VCN 418. Instead, the IaaS provider may own or operate the control plane VCN 416 and the data plane VCN 418. The control plane VCN 416 and the data plane VCN 418 may be implemented in the service tenancy 419. This embodiment can enable isolation of networks that may prevent users or customers from interacting with other users′, or other customers′, resources. Also, this embodiment may allow users, or customers, of the system to store databases privately without needing to rely on public Internet 454 for storage.

In other embodiments, the LB subnet(s) 422 implemented in the control plane VCN 416 can be configured to receive a signal from the service gateway 436. In this embodiment, the control plane VCN 416 and the data plane VCN 418 may be configured to be called by a customer of the IaaS provider without calling public Internet 454. Customers of the IaaS provider may need this embodiment since database(s) that the customers use may be controlled by the IaaS provider and may be stored on the service tenancy 419. The service tenancy 419 may be isolated from public Internet 454.

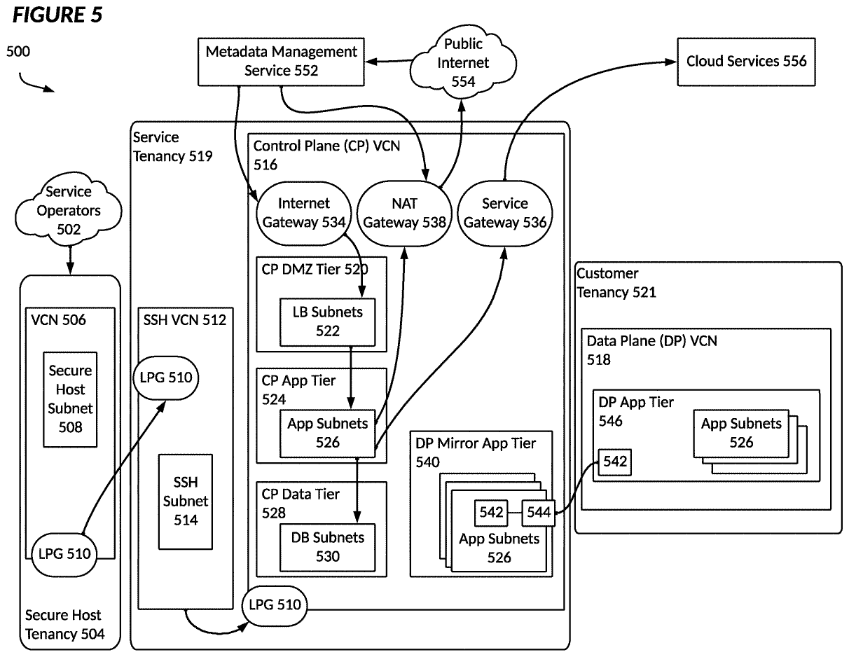

FIG. 5 is a block diagram illustrating another example pattern of an IaaS architecture 2 according to at least one embodiment. Service operators 502 (e.g., service operators 402 of FIG. 4) can be communicatively coupled to a secure host tenancy 504 (e.g., the secure host tenancy 404 of FIG. 4) that can include a virtual cloud network (VCN) 506 (e.g., the VCN 406 of FIG. 4) and a secure host subnet 508 (e.g., the secure host subnet 408 of FIG. 4). The VCN 506 can include a local peering gateway (LPG) 510 (e.g., the LPG 410 of FIG. 4) that can be communicatively coupled to a secure shell (SSH) VCN 512 (e.g., the SSH VCN 412 of FIG. 4) via an LPG 510 implemented in the SSH VCN 512. The SSH VCN 512 can include an SSH subnet 514 (e.g., the SSH subnet 414 of FIG. 4), and the SSH VCN 512 can be communicatively coupled to a control plane VCN 516 (e.g., the control plane VCN 416 of FIG. 4) via an LPG 510 implemented in the control plane VCN 516. The control plane VCN 516 can be implemented in a service tenancy 519 (e.g., the service tenancy 419 of FIG. 4), and the data plane VCN 518 (e.g., the data plane VCN 418 of FIG. 4) can be implemented in a customer tenancy 521 that may be owned or operated by users, or customers, of the system.

The control plane VCN 516 can include a control plane DMZ tier 520 (e.g., the control plane DMZ tier 420 of FIG. 4) that can include LB subnet(s) 522 (e.g., LB subnet(s) 422 of FIG. 4), a control plane app tier 524 (e.g., the control plane app tier 424 of FIG. 4) that can include app subnet(s) 526 (e.g., app subnet(s) 426 of FIG. 4), and a control plane data tier 528 (e.g., the control plane data tier 428 of FIG. 4) that can include database (DB) subnet(s) 530 (e.g., similar to DB subnet(s) 430 of FIG. 4). The LB subnet(s) 522 implemented in the control plane DMZ tier 520 can be communicatively coupled to the app subnet(s) 526 implemented in the control plane app tier 524 and an Internet gateway 534 (e.g., the Internet gateway 434 of FIG. 4) that can be implemented in the control plane VCN 516. The app subnet(s) 526 can be communicatively coupled to the DB subnet(s) 530 implemented in the control plane data tier 528 and a service gateway 536 (e.g., the service gateway 436 of FIG. 4) and a network address translation (NAT) gateway 538 (e.g., the NAT gateway 438 of FIG. 4). The control plane VCN 516 can include the service gateway 536 and the NAT gateway 538.

The control plane VCN 516 can include a data plane mirror app tier 540 (e.g., the data plane mirror app tier 440 of FIG. 4) that can include app subnet(s) 526. The app subnet(s) 526 implemented in the data plane mirror app tier 540 can include a virtual network interface controller (VNIC) 542 (e.g., the VNIC of 442) that can execute a compute instance 544 (e.g., similar to the compute instance 444 of FIG. 4). The compute instance 544 can facilitate communication between the app subnet(s) 526 of the data plane mirror app tier 540 and the app subnet(s) 526 that can be implemented in a data plane app tier 546 (e.g., the data plane app tier 446 of FIG. 4). The compute instance 544 can facilitate this communication via the VNIC 542 implemented in the data plane mirror app tier 540 and the VNIC 542 implemented in the data plane app tier 546.

The Internet gateway 534 implemented in the control plane VCN 516 can be communicatively coupled to a metadata management service 552 (e.g., the metadata management service 452 of FIG. 4) that can be communicatively coupled to public Internet 554 (e.g., public Internet 454 of FIG. 4). Public Internet 554 can be communicatively coupled to the NAT gateway 538 implemented in the control plane VCN 516. The service gateway 536 implemented in the control plane VCN 516 can be communicatively couple to cloud services 556 (e.g., cloud services 456 of FIG. 4).

In some examples, the data plane VCN 518 can be implemented in the customer tenancy 521. In this case, the IaaS provider may provide the control plane VCN 516 for a customer, and the IaaS provider may, for a customer, set up a unique, compute instance 544 that is implemented in the service tenancy 519. A compute instance 544 may allow communication between the control plane VCN 516 implemented in the service tenancy 519 and the data plane VCN 518 that is implemented in the customer tenancy 521. The compute instance 544 may allow resources provisioned in the control plane VCN 516 that is implemented in the service tenancy 519 to be deployed or otherwise used in the data plane VCN 518 that is implemented in the customer tenancy 521.

In other examples, the customer of the IaaS provider may have databases that are implemented in the customer tenancy 521. In this example, the control plane VCN 516 can include the data plane mirror app tier 540 that can include app subnet(s) 526. The data plane mirror app tier 540 can be implemented in the control plane VCN 516, but the data plane mirror app tier 540 may not be implemented in the data plane VCN 518. That is, the data plane mirror app tier 540 may have access to the customer tenancy 521, but the data plane mirror app tier 540 may not exist in the data plane VCN 518 or be owned or operated by the customer of the IaaS provider. The data plane mirror app tier 540 may be configured to make calls to the data plane VCN 518 but may not be configured to make calls to any entity implemented in the control plane VCN 516. The customer may need to deploy or otherwise use resources in the data plane VCN 518 that are provisioned in the control plane VCN 516, and the data plane mirror app tier 540 can facilitate the deployment or other usage of resources of the customer.

In some embodiments, the customer of the IaaS provider can apply filters to the data plane VCN 518. In this embodiment, the customer can determine what the data plane VCN 518 can access, and the customer may restrict access to public Internet 554 from the data plane VCN 518. The IaaS provider may not be able to apply filters or otherwise control access of the data plane VCN 518 to any outside networks or databases. Applying filters and controls by the customer onto the data plane VCN 518, implemented in the customer tenancy 521, can help isolate the data plane VCN 518 from other customers and from public Internet 554.

In some embodiments, cloud services 556 can be called by the service gateway 536 to access services that may not exist on public Internet 554, on the control plane VCN 516, or on the data plane VCN 518. The connection between cloud services 556 and the control plane VCN 516 or the data plane VCN 518 may not be active or continuous. Cloud services 556 may exist on a different network owned or operated by the IaaS provider. Cloud services 556 may be configured to receive calls from the service gateway 536 and may be configured to not receive calls from public Internet 554. Some cloud services 556 may be isolated from other cloud services 556, and the control plane VCN 516 may be isolated from cloud services 556 that may not be in the same region as the control plane VCN 516. For example, the control plane VCN 516 may be located in “Region 1,” and cloud service “Deployment 1” may be located in Region 1 and in “Region 2.” If a call to Deployment 1 is made by the service gateway 536 implemented in the control plane VCN 516 located in Region 1, the call may be transmitted to Deployment 1 in Region 1. In this example, the control plane VCN 516, or Deployment 1 in Region 1, may not be communicatively coupled to, or otherwise in communication with, Deployment 1 in Region 2.

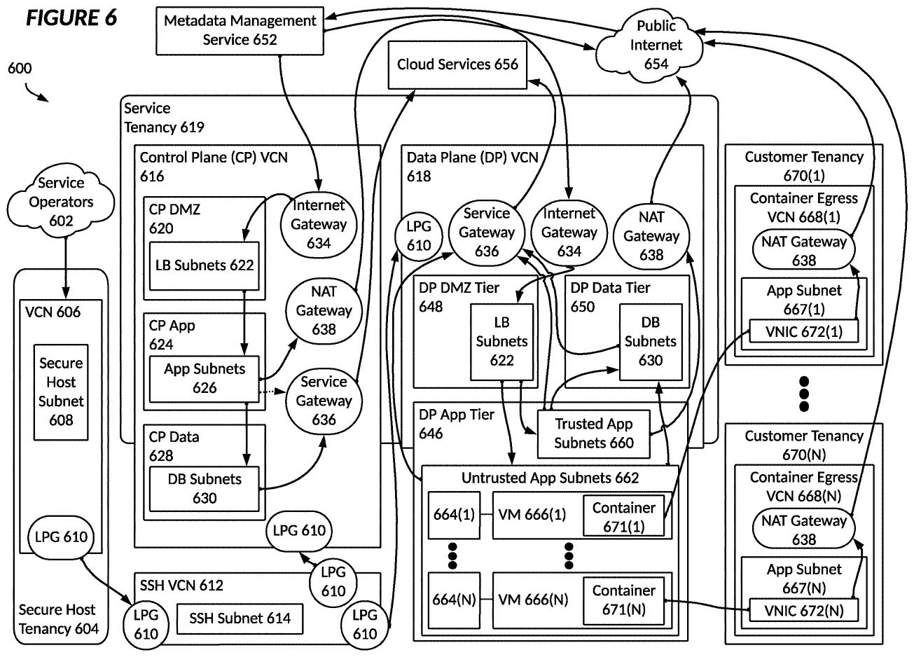

FIG. 6 is a block diagram illustrating another example pattern of an IaaS architecture 600 according to at least one embodiment. Service operators 602 (e.g., service operators 402 of FIG. 4) can be communicatively coupled to a secure host tenancy 604 (e.g., the secure host tenancy 404 of FIG. 4) that can include a virtual cloud network (VCN) 606 (e.g., the VCN 406 of FIG. 4) and a secure host subnet 608 (e.g., the secure host subnet 408 of FIG. 4). The VCN 606 can include an LPG 610 (e.g., the LPG 410 of FIG. 4) that can be communicatively coupled to an SSH VCN 612 (e.g., the SSH VCN 412 of FIG. 4) via an LPG 610 implemented in the SSH VCN 612. The SSH VCN 612 can include an SSH subnet 614 (e.g., the SSH subnet 414 of FIG. 4), and the SSH VCN 612 can be communicatively coupled to a control plane VCN 616 (e.g., the control plane VCN 416 of FIG. 4) via an LPG 610 implemented in the control plane VCN 616 and to a data plane VCN 618 (e.g., the data plane VCN 418 of FIG. 4) via an LPG 610 implemented in the data plane VCN 618. The control plane VCN 616 and the data plane VCN 618 can be implemented in a service tenancy 619 (e.g., the service tenancy 419 of FIG. 4).

The control plane VCN 616 can include a control plane DMZ tier 620 (e.g., the control plane DMZ tier 420 of FIG. 4) that can include load balancer (LB) subnet(s) 622 (e.g., LB subnet(s) 422 of FIG. 4), a control plane app tier 624 (e.g., the control plane app tier 424 of FIG. 4) that can include app subnet(s) 626 (e.g., similar to app subnet(s) 426 of FIG. 4), and a control plane data tier 628 (e.g., the control plane data tier 428 of FIG. 4) that can include DB subnet(s) 630. The LB subnet(s) 622 implemented in the control plane DMZ tier 620 can be communicatively coupled to the app subnet(s) 626 implemented in the control plane app tier 624 and to an Internet gateway 634 (e.g., the Internet gateway 434 of FIG. 4) that can be implemented in the control plane VCN 616, and the app subnet(s) 626 can be communicatively coupled to the DB subnet(s) 630 implemented in the control plane data tier 628 and to a service gateway 636 (e.g., the service gateway of FIG. 4) and a network address translation (NAT) gateway 638 (e.g., the NAT gateway 438 of FIG. 4). The control plane VCN 616 can include the service gateway 636 and the NAT gateway 638.

The data plane VCN 618 can include a data plane app tier 646 (e.g., the data plane app tier 446 of FIG. 4), a data plane DMZ tier 648 (e.g., the data plane DMZ tier 448 of FIG. 4), and a data plane data tier 650 (e.g., the data plane data tier 450 of FIG. 4). The data plane DMZ tier 648 can include LB subnet(s) 622 that can be communicatively coupled to trusted app subnet(s) 660, untrusted app subnet(s) 662 of the data plane app tier 646, and the Internet gateway 634 implemented in the data plane VCN 618. The trusted app subnet(s) 660 can be communicatively coupled to the service gateway 636 implemented in the data plane VCN 618, the NAT gateway 638 implemented in the data plane VCN 618, and DB subnet(s) 630 implemented in the data plane data tier 650. The untrusted app subnet(s) 662 can be communicatively coupled to the service gateway 636 implemented in the data plane VCN 618 and DB subnet(s) 630 implemented in the data plane data tier 650. The data plane data tier 650 can include DB subnet(s) 630 that can be communicatively coupled to the service gateway 636 implemented in the data plane VCN 618.

The untrusted app subnet(s) 662 can include one or more primary VNICs 664(1)-(N) that can be communicatively coupled to tenant virtual machines (VMs) 666(1)-(N). Tenant VMs 666(1)-(N) can be communicatively coupled to a respective app subnets 667(1)-(N) that can be implemented in respective container egress VCNs 668(1)-(N) that can be implemented in respective customer tenancies 670(1)-(N). Respective secondary VNICs 672(1)-(N) can facilitate communication between the untrusted app subnet(s) 662 implemented in the data plane VCN 618 and the app subnet implemented in the container egress VCNs 668(1)-(N). Container egress VCNs 668(1)-(N) can include a NAT gateway 638 that can be communicatively coupled to public Internet 654 (e.g., public Internet 454 of FIG. 4).

The Internet gateway 634 implemented in the control plane VCN 616 and implemented in the data plane VCN 618 can be communicatively coupled to a metadata management service 652 (e.g., the metadata management service 452 of FIG. 4) that can be communicatively coupled to public Internet 654. Public Internet 654 can be communicatively coupled to the NAT gateway 638 implemented in the control plane VCN 616 and implemented in the data plane VCN 618. The service gateway 636 implemented in the control plane VCN 616 and implemented in the data plane VCN 618 can be communicatively couple to cloud services 656.

In some embodiments, the data plane VCN 618 can be integrated with customer tenancies 670(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 646. Code to execute the function may be executed in the VMs 666(1)-(N), and the code may not be configured to execute anywhere else on the data plane VCN 618. VMs 666(1)-(N) may be connected to one customer tenancy 670(1). Respective containers 671(1)-(N) implemented in the VMs 666(1)-(N) may be configured to execute the code. In this case, there can be a dual isolation (e.g., the containers 671(1)-(N) executing code), where the containers 671(1)-(N) may be implemented in at least the VM 666(1)-(N) that are implemented in the untrusted app subnet(s) 662) that may help prevent incorrect or otherwise undesirable code from damaging the network of the IaaS provider or from damaging a network of a different customer. The containers 671(1)-(N) may be communicatively coupled to the customer tenancy 670 and may be configured to transmit or receive data from the customer tenancy 670. The containers 671(1)-(N) may not be configured to transmit or receive data from any other entity in the data plane VCN 618. Upon completing execution of the code, the IaaS provider may terminate or otherwise dispose of the containers 671(1)-(N).

In some embodiments, the trusted app subnet(s) 660 may execute code that may be owned or operated by the IaaS provider. In this embodiment, the trusted app subnet(s) 660 may be communicatively coupled to the DB subnet(s) 630 and be configured to execute CRUD operations in the DB subnet(s) 630. The untrusted app subnet(s) 662 may be communicatively coupled to the DB subnet(s) 630, but in this embodiment, the untrusted app subnet(s) may be configured to execute read operations in the DB subnet(s) 630. The containers 671(1)-(N) that can be implemented in the VM 666(1)-(N) of a customer and that may execute code from the customer may not be communicatively coupled with the DB subnet(s) 630.

In other embodiments, the control plane VCN 616 and the data plane VCN 618 may not be directly communicatively coupled. In this embodiment, there may be no direct communication between the control plane VCN 616 and the data plane VCN 618. However, communication can occur indirectly through at least one method. An LPG 610 may be established by the IaaS provider that can facilitate communication between the control plane VCN 616 and the data plane VCN 618. In another example, the control plane VCN 616 or the data plane VCN 618 can make a call to cloud services 656 via the service gateway 636. For example, a call to cloud services 656 from the control plane VCN 616 can include a request for a service that can communicate with the data plane VCN 618.

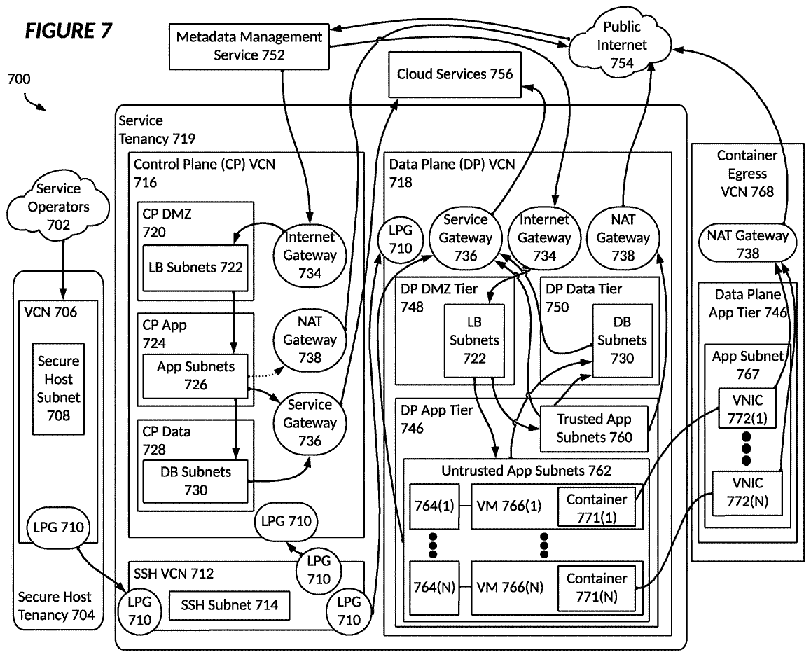

FIG. 7 is a block diagram illustrating another example pattern of an IaaS architecture 700 according to at least one embodiment. Service operators 702 (e.g., service operators 402 of FIG. 4) can be communicatively coupled to a secure host tenancy 704 (e.g., the secure host tenancy 404 of FIG. 4) that can include a virtual cloud network (VCN) 706 (e.g., the VCN 406 of FIG. 4) and a secure host subnet 708 (e.g., the secure host subnet 408 of FIG. 4). The VCN 706 can include an LPG 710 (e.g., the LPG 410 of FIG. 4) that can be communicatively coupled to an SSH VCN 712 (e.g., the SSH VCN 412 of FIG. 4) via an LPG 710 implemented in the SSH VCN 712. The SSH VCN 712 can include an SSH subnet 714 (e.g., the SSH subnet 414 of FIG. 4), and the SSH VCN 712 can be communicatively coupled to a control plane VCN 716 (e.g., the control plane VCN 416 of FIG. 4) via an LPG 710 implemented in the control plane VCN 716 and to a data plane VCN 718 (e.g., the data plane VCN 418 of FIG. 4) via an LPG 710 implemented in the data plane VCN 718. The control plane VCN 716 and the data plane VCN 718 can be implemented in a service tenancy 719 (e.g., the service tenancy 419 of FIG. 4).

The control plane VCN 716 can include a control plane DMZ tier 720 (e.g., the control plane DMZ tier 420 of FIG. 4) that can include LB subnet(s) 722 (e.g., LB subnet(s) 422 of FIG. 4), a control plane app tier 724 (e.g., the control plane app tier 424 of FIG. 4) that can include app subnet(s) 726 (e.g., app subnet(s) 426 of FIG. 4), and a control plane data tier 728 (e.g., the control plane data tier 428 of FIG. 4) that can include DB subnet(s) 730 (e.g., DB subnet(s) 630 of FIG. 6). The LB subnet(s) 722 implemented in the control plane DMZ tier 720 can be communicatively coupled to the app subnet(s) 726 implemented in the control plane app tier 724 and to an Internet gateway 734 (e.g., the Internet gateway 434 of FIG. 4) that can be implemented in the control plane VCN 716, and the app subnet(s) 726 can be communicatively coupled to the DB subnet(s) 730 implemented in the control plane data tier 728 and to a service gateway 736 (e.g., the service gateway of FIG. 4) and a network address translation (NAT) gateway 738 (e.g., the NAT gateway 438 of FIG. 4). The control plane VCN 716 can include the service gateway 736 and the NAT gateway 738.

The data plane VCN 718 can include a data plane app tier 746 (e.g., the data plane app tier 446 of FIG. 4), a data plane DMZ tier 748 (e.g., the data plane DMZ tier 448 of FIG. 4), and a data plane data tier 750 (e.g., the data plane data tier 450 of FIG. 4). The data plane DMZ tier 748 can include LB subnet(s) 722 that can be communicatively coupled to trusted app subnet(s) 760 (e.g., trusted app subnet(s) 660 of FIG. 6) and untrusted app subnet(s) 762 (e.g., untrusted app subnet(s) 662 of FIG. 6) of the data plane app tier 746 and the Internet gateway 734 implemented in the data plane VCN 718. The trusted app subnet(s) 760 can be communicatively coupled to the service gateway 736 implemented in the data plane VCN 718, the NAT gateway 738 implemented in the data plane VCN 718, and DB subnet(s) 730 implemented in the data plane data tier 750. The untrusted app subnet(s) 762 can be communicatively coupled to the service gateway 736 implemented in the data plane VCN 718 and DB subnet(s) 730 implemented in the data plane data tier 750. The data plane data tier 750 can include DB subnet(s) 730 that can be communicatively coupled to the service gateway 736 implemented in the data plane VCN 718.

The untrusted app subnet(s) 762 can include primary VNICs 764(1)-(N) that can be communicatively coupled to tenant virtual machines (VMs) 766(1)-(N) implemented within the untrusted app subnet(s) 762. Tenant VMs 766(1)-(N) can execute code in a respective container 767(1)-(N) and be communicatively coupled to an app subnet 767 that can be implemented in a data plane app tier 746 that can be implemented in a container egress VCN 768. Respective secondary VNICs 772(1)-(N) can facilitate communication between the untrusted app subnet(s) 762 implemented in the data plane VCN 718 and the app subnet 767 implemented in the container egress VCN 768. The container egress VCN 768 can include a NAT gateway 738 that can be communicatively coupled to public Internet 754 (e.g., public Internet 454 of FIG. 4).

The Internet gateway 734 implemented in the control plane VCN 716 and implemented in the data plane VCN 718 can be communicatively coupled to a metadata management service 752 (e.g., the metadata management service 452 of FIG. 4) that can be communicatively coupled to public Internet 754. Public Internet 754 can be communicatively coupled to the NAT gateway 738 implemented in the control plane VCN 716 and implemented in the data plane VCN 718. The service gateway 736 implemented in the control plane VCN 716 and implemented in the data plane VCN 718 can be communicatively couple to cloud services 756.

In some examples, the pattern illustrated by the architecture of block diagram 700 of FIG. 7 may be considered an exception to the pattern illustrated by the architecture of block diagram 600 of FIG. 6 and may be needed for a customer of the IaaS provider if the IaaS provider cannot directly communicate with the customer (e.g., a disconnected region). The respective containers 771(1)-(N) that are implemented in the VMs 766(1)-(N) for a customer can be accessed in real-time by the customer. The containers 771(1)-(N) may be configured to make calls to respective secondary VNICs 772(1)-(N) implemented in app subnet(s) 767 of the data plane app tier 746 that can be implemented in the container egress VCN 768. The secondary VNICs 772(1)-(N) can transmit the calls to the NAT gateway 738 that may transmit the calls to public Internet 754. In this example, the containers 771(1)-(N) that can be accessed in real time by the customer can be isolated from the control plane VCN 716 and can be isolated from other entities implemented in the data plane VCN 718. The containers 771(1)-(N) may also be isolated from resources from other customers.

In other examples, the customer can use the containers 771(1)-(N) to call cloud services 756. In this example, the customer may execute code in the containers 771(1)-(N) that request a service from cloud services 756. The containers 771(1)-(N) can transmit this request to the secondary VNICs 772(1)-(N) that can transmit the request to the NAT gateway 738 that can transmit the request to public Internet 754. Public Internet 754 can transmit the request to LB subnet(s) 722 implemented in the control plane VCN 716 via the Internet gateway 734. In response to determining the request is valid, the LB subnet(s) can transmit the request to app subnet(s) 726 that can transmit the request to cloud services 756 via the service gateway 736.

It should be appreciated that IaaS architectures 400, 500, 600, and 700 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. EXAMPLES OF CLOUD NETWORKS

As noted above, infrastructure as a service (IaaS) is one particular type of cloud computing service. In an IaaS model, customers can build their own customizable virtual or overlay networks and deploy customer resources over on-demand, scalable computing resources of CI.

The CI may comprise interconnected high-performance compute resources including various host machines, memory resources, and network resources that form a physical network, which is also referred to as a substrate network or an underlay network. The resources in CI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)) Virtual Extensible LAN (VXLAN—IETF RFC 5348), Virtual Private Networks (VPNs) (e.g., MPLS Layer-3 Virtual Private Networks (RFC 4364)), VMware's NSX, GENEVE (Generic Network Virtualization Encapsulation), and others.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CI is physically hosted in one or more data centers in one or more regions around the world. The CI may include components in the physical or substrate network and virtualized components (e.g., virtual networks, compute instances, virtual machines, etc.) that are in a virtual network built on top of the physical network components. In certain embodiments, the CI is organized and hosted in realms, regions, and availability domains.

When a customer subscribes to an IaaS service, resources from CI are provisioned for the customer and associated with the customer's tenancy. The customer can use these provisioned resources to build private networks and deploy resources on these networks. The customer networks that are hosted in the cloud by the CI are referred to as virtual cloud networks (VCNs). A customer can set up one or more virtual cloud networks (VCNs) using CI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with publicly accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints. CI thus offers high-performance compute resources and storage capacity in flexible virtual networks that are securely accessible from various networked locations such as from a customer's on-premise network.

The CP may provide various services using the CI. In some instances, customers of CI may themselves act like service providers and provide services using CI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 8.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 8.0.0.0/24 and 8.0.1.0/24) that do not overlap with other subnets in that VCN, and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet includes the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 8.0.0.0/24 and 8.0.1.0/24) that do not overlap with other subnets in that VCN, and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

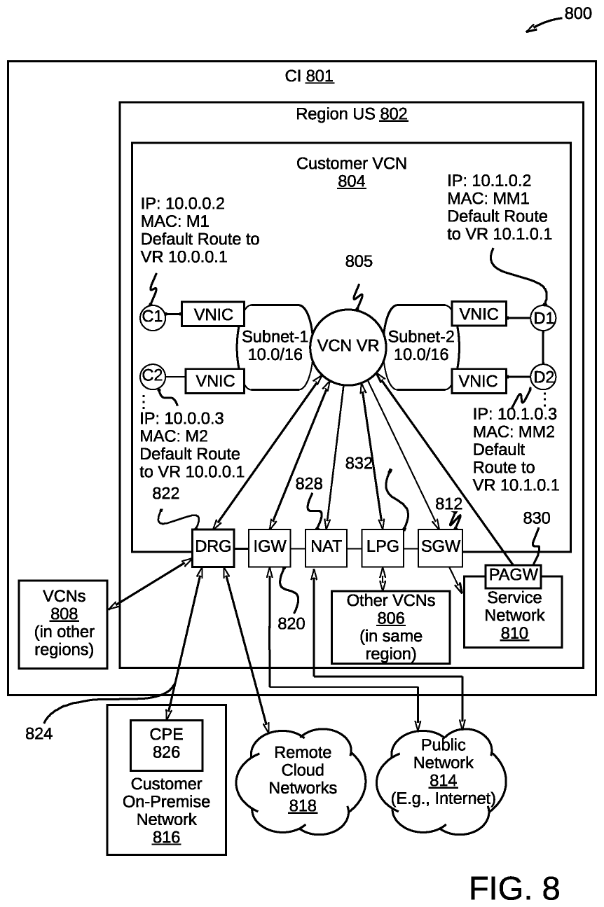

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 8. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 8.0/16 and 8.1/16, respectively. For the first subnet within the VCN with address range 8.0/16, an address from this range is reserved for a port of the VCN VR for that subnet. In some instances, the first IP address from the range may be reserved for the VCN VR. For example, for the subnet with overlay IP address range 8.0/16, IP address 8.0.0.1 may be reserved for a port of the VCN VR for that subnet. For the second subnet within the same VCN with address range 8.1/16, the VCN VR may have a port for that second subnet with IP address 8.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group includes of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

In certain embodiments, the creation of VCNs and subnets are handled by a VCN Control Plane (CP), and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane.

A customer may create one or more VCNs using resources hosted by CI. A compute instance deployed on a customer VCN may communicate with different endpoints. These endpoints can include endpoints that are hosted by CI and endpoints outside CI.

Various different architectures for implementing cloud-based service using CI are depicted in FIGS. 8-11, and are described below. FIG. 8 is a high-level diagram of a distributed environment 800 showing an overlay or customer VCN hosted by CI according to certain embodiments. The distributed environment depicted in FIG. 8 includes multiple components in the overlay network. Distributed environment 800 depicted in FIG. 8 is merely an example and is not intended to unduly limit the scope of claimed embodiments. Many variations, alternatives, and modifications are possible. For example, in some implementations, the distributed environment depicted in FIG. 8 may have more or fewer systems or components than those shown in FIG. 8, may combine two or more systems, or may have a different configuration or arrangement of systems.

As shown in the example depicted in FIG. 8, distributed environment 800 comprises CI 801 that provides services and resources that customers can subscribe to and use to build their virtual cloud networks (VCNs). In certain embodiments, CI 801 offers IaaS services to subscribing customers. The data centers within CI 801 may be organized into one or more regions. One example region “Region US” 802 is shown in FIG. 8. A customer has configured a customer VCN c/o Oracle International Corporation for region 802. The customer may deploy various compute instances on VCN 804, where the compute instances may include virtual machines or bare metal instances. Examples of instances include applications, database, load balancers, and the like.

In the embodiment depicted in FIG. 8, customer VCN 804 comprises two subnets, namely, “Subnet-1” and “Subnet-2”, each subnet with its own CIDR IP address range. In FIG. 8, the overlay IP address range for Subnet-1 is 8.0/16 and the address range for Subnet-2 is 8.1/16. A VCN Virtual Router 805 represents a logical gateway for the VCN that enables communications between subnets of the VCN 804, and with other endpoints outside the VCN. VCN VR 805 is configured to route traffic between VNICs in VCN 804 and gateways associated with VCN 804. VCN VR 805 provides a port for each subnet of VCN 804. For example, VR 805 may provide a port with IP address 8.0.0.1 for Subnet-1 and a port with IP address 8.1.0.1 for Subnet-2.

Multiple compute instances may be deployed on each subnet, where the compute instances can be virtual machine instances, and/or bare metal instances. The compute instances in a subnet may be hosted by one or more host machines within CI 801. A compute instance participates in a subnet via a VNIC associated with the compute instance. For example, as shown in FIG. 8, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 8, compute instance C1 has an overlay IP address of 8.0.0.2 and a MAC address of M1, while compute instance C2 has a private overlay IP address of 8.0.0.3 and a MAC address of M2. Each compute instance in Subnet-1, including compute instances C1 and C2, has a default route to VCN VR 805 using IP address 8.0.0.1, which is the IP address for a port of VCN VR 805 for Subnet-1.

Subnet-2 can have multiple compute instances deployed on it, including virtual machine instances and/or bare metal instances. For example, as shown in FIG. 8, compute instances D1 and D2 are part of Subnet-2 via VNICs associated with the respective compute instances. In the embodiment depicted in FIG. 8, compute instance D1 has an overlay IP address of 8.1.0.2 and a MAC address of MM1, while compute instance D2 has a private overlay IP address of 8.1.0.3 and a MAC address of MM2. Each compute instance in Subnet-2, including compute instances D1 and D2, has a default route to VCN VR 805 using IP address 8.1.0.1, which is the IP address for a port of VCN VR 805 for Subnet-2.

VCN 804 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 804 can communicate with various different endpoints. These endpoints may include endpoints that are hosted by CI 801 and endpoints outside CI 801. Endpoints that are hosted by CI 801 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 806 or 810, communications between a compute instance in Subnet-1 and an endpoint in service network 810 in the same region); or an endpoint in a VCN in a different region (e.g., communications between a compute instance in Subnet-1 and an endpoint in a VCN in a different region 808). A compute instance in a subnet hosted by CI 801 may also communicate with endpoints that are not hosted by CI 801 (i.e., are outside CI 801). These outside endpoints include endpoints in the customer's on-premise network 816, endpoints within other remote cloud hosted networks 818, public endpoints 814 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 8 wants to send a packet to compute instance D1 in Subnet-2, the packet is first processed by the VNIC associated with compute instance C1. The VNIC associated with compute instance C1 is configured to route the packet to the VCN VR 805 using default route or port 8.0.0.1 of the VCN VR. VCN VR 805 is configured to route the packet to Subnet-2 using port 8.1.0.1. The packet is then received and processed by the VNIC associated with D1 and the VNIC forwards the packet to compute instance D1.

For a packet to be communicated from a compute instance in VCN 804 to an endpoint that is outside VCN 804, the communication is facilitated by the VNIC associated with the source compute instance, VCN VR 805, and gateways associated with VCN 804. One or more types of gateways may be associated with VCN 804. A gateway is an interface between a VCN and another endpoint, where another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 804. The packet may be first processed by the VNIC associated with source compute instance C1. The VNIC processing determines that the destination for the packet is outside the Subnet-1 of C1. The VNIC associated with C1 may forward the packet to VCN VR 805 for VCN 804. VCN VR 805 then processes the packet and as part of the processing, based upon the destination for the packet, determines a particular gateway associated with VCN 804 as the next hop for the packet. VCN VR 805 may then forward the packet to the particular identified gateway. For example, if the destination is an endpoint within the customer's on-premise network, then the packet may be forwarded by VCN VR 805 to Dynamic Routing Gateway (DRG) gateway 822 configured for VCN 804. The packet may then be forwarded from the gateway to a next hop to facilitate communication of the packet to it final intended destination.

Various different types of gateways may be configured for a VCN. Examples of gateways that may be configured for a VCN are depicted in FIG. 8 and described below. As shown in the embodiment depicted in FIG. 8, a Dynamic Routing Gateway (DRG) 822 may be added to or be associated with customer VCN 804 and provides a path for private network traffic communication between customer VCN 804 and another endpoint, where another endpoint can be the customer's on-premise network 816, a VCN 808 in a different region of CI 801, or other remote cloud networks 818 not hosted by CI 801. Customer on-premise network 816 may be a customer network or a customer data center built using the customer's resources. Access to customer on-premise network 816 is generally very restricted. For a customer that has both a customer on-premise network 816 and one or more VCNs 804 deployed or hosted in the cloud by CI 801, the customer may want their on-premise network 816 and their cloud based VCN 804 to be able to communicate with each other. This enables a customer to build an extended hybrid environment encompassing the customer's VCN 804 hosted by CI 801 and their on-premise network 816. DRG 822 enables this communication. To enable such communications, a communication channel 824 is set up where one endpoint of the channel is in customer on-premise network 816 and the other endpoint is in CI 801 and connected to customer VCN 804. Communication channel 824 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 816 that forms one end point for communication channel 824 is referred to as the customer premise equipment (CPE), such as CPE 826 depicted in FIG. 8. On the CI 801 side, the endpoint may be a host machine executing DRG 822.

In certain embodiments, a Remote Peering Connection (RPC) can be added to a DRG, which allows a customer to peer one VCN with another VCN in a different region. Using such an RPC, customer VCN 804 can use DRG 822 to connect with a VCN 808 in another region. DRG 822 may also be used to communicate with other remote cloud networks 818, not hosted by CI 801 such as a Microsoft Azure cloud, Amazon AWS cloud, and others.

As shown in FIG. 8, an Internet Gateway (IGW) 820 may be configured for customer VCN 804 the enables a compute instance on VCN 804 to communicate with public endpoints 814 accessible over a public network such as the Internet. IGW 820 is a gateway that connects a VCN to a public network such as the Internet. IGW 820 enables a public subnet (where the resources in the public subnet have public overlay IP addresses) within a VCN, such as VCN 804, direct access to public endpoints 812 on a public network 814 such as the Internet. Using IGW 820, connections can be initiated from a subnet within VCN 804 or from the Internet.

A Network Address Translation (NAT) gateway 828 can be configured for customer's VCN 804 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 804, with private access to public endpoints on the Internet. In NAT gateways, connections can be initiated only from the private subnet to the public Internet and not from the Internet to the private subnet.

In certain embodiments, a Service Gateway (SGW) 826 can be configured for customer VCN 804 and provides a path for private network traffic between VCN 804 and supported services endpoints in a service network 810. In certain embodiments, service network 810 may be provided by the CP and may provide various services. An example of such a service network is Oracle's Services Network, which provides various services that can be used by customers. For example, a compute instance (e.g., a database system) in a private subnet of customer VCN 804 can back up data to a service endpoint (e.g., Object Storage) without needing public IP addresses or access to the Internet. In certain embodiments, a VCN can have only one SGW, and connections can only be initiated from a subnet within the VCN and not from service network 810. If a VCN is peered with another, resources in the other VCN typically cannot access the SGW. Resources in on-premise networks that are connected to a VCN with FastConnect or VPN Connect can also use the service gateway configured for that VCN.

In certain implementations, SGW 826 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 832 is a gateway that can be added to customer VCN 804 and enables VCN 804 to peer with another VCN in the same region. Peering means that the VCNs communicate using private IP addresses, without the traffic traversing a public network such as the Internet or without routing the traffic through the customer's on-premise network 816. In preferred embodiments, a VCN has a separate LPG for each peering it establishes. Local Peering or VCN Peering is a common practice used to establish network connectivity between different applications or infrastructure management functions.

Service providers, such as providers of services in service network 810, may provide access to services using different access models. According to a public access model, services may be exposed as public endpoints that are publicly accessible by compute instance in a customer VCN via a public network such as the Internet and or may be privately accessible via SGW 826. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 830 is a gateway resource that can be attached to a service provider VCN (e.g., a VCN in service network 810) that acts as an ingress/egress point for all traffic from/to customer subnet private endpoints. PAGW 830 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 830 to the service. These are referred to as customer-to-service private connections (C2S connections).

The PE concept can also be used to extend the private access for the service to customer's on-premise networks and data centers, by allowing the traffic to flow through FastConnect/IPsec links and the private endpoint in the customer VCN. Private access for the service can also be extended to the customer's peered VCNs, by allowing the traffic to flow between LPG 832 and the PE in the customer's VCN.

A customer can control routing in a VCN at the subnet level, so the customer can specify which subnets in the customer's VCN, such as VCN 804, use each gateway. A VCN's route tables are used to decide if traffic is allowed out of a VCN through a particular gateway. For example, in a particular instance, a route table for a public subnet within customer VCN 804 may send non-local traffic through IGW 820. The route table for a private subnet within the same customer VCN 804 may send traffic destined for CP services through SGW 826. All remaining traffic may be sent via the NAT gateway 828. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked, and the response is automatically allowed without an explicit security list rule for the response traffic) or stateless.

Access from a customer VCN (i.e., by a resource or compute instance deployed on VCN 804) can be categorized as public access, private access, or dedicated access. Public access refers to an access model where a public IP address or a NAT is used to access a public endpoint. Private access enables customer workloads in VCN 804 with private IP addresses (e.g., resources in a private subnet) to access services without traversing a public network such as the Internet. In certain embodiments, CI 801 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CI may offer dedicated public access using technologies such as FastConnect public peering where customer on-premise instances can access one or more services in a customer VCN using a FastConnect connection and without traversing a public network such as the Internet. CI also may also offer dedicated private access using FastConnect private peering where customer on-premise instances with private IP addresses can access the customer's VCN workloads using a FastConnect connection. FastConnect is a network connectivity alternative to using the public Internet to connect a customer's on-premise network to CI and its services. FastConnect provides an easy, elastic, and economical way to create a dedicated and private connection with higher bandwidth options and a more reliable and consistent networking experience when compared to Internet-based connections.

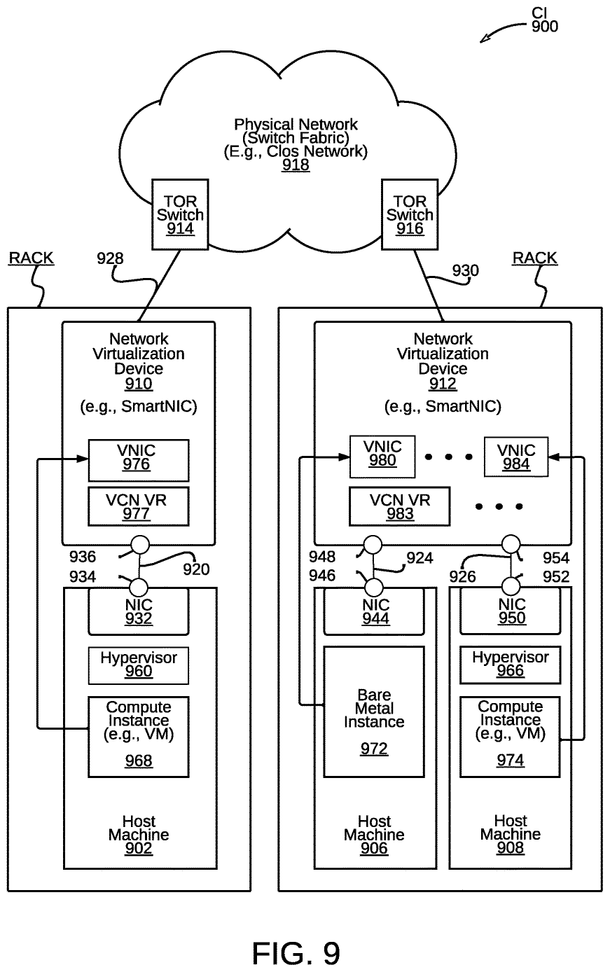

FIG. 9 and the accompanying description above describes various virtualized components in an example virtual network. As described above, the virtual network is built on the underlying physical or substrate network. FIG. 9 depicts a simplified architectural diagram of the physical components in the physical network within CI 900 that provide the underlay for the virtual network according to certain embodiments. As shown, CI 900 provides a distributed environment comprising components and resources (e.g., compute, memory, and networking resources) provided by a cloud service provider (CP). These components and resources are used to provide cloud services (e.g., IaaS services) to subscribing customers, i.e., customers that have subscribed to one or more services provided by the CP. Based upon the services subscribed to by a customer, a subset of resources (e.g., compute, memory, and networking resources) of CI 900 are provisioned for the customer. Customers can then build their own cloud-based (i.e., CI-hosted) customizable and private virtual networks using physical compute, memory, and networking resources provided by CI 900. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CI 900 provides infrastructure and a set of complementary cloud services that enable customers to build and run a wide range of applications and services in a highly available hosted environment.

In the example embodiment depicted in FIG. 9, the physical components of CI 900 include one or more physical host machines or physical servers (e.g., 902, 906, 908), network virtualization devices (NVDs) (e.g., 910, 912), top-of-rack (TOR) switches (e.g., 914, 916), and a physical network (e.g., 918), and switches in physical network 918. The physical host machines or servers may host and execute various compute instances that participate in one or more subnets of a VCN. The compute instances may include virtual machine instances, and bare metal instances. For example, the various compute instances depicted in FIG. 8 may be hosted by the physical host machines depicted in FIG. 9. The virtual machine compute instances in a VCN may be executed by one host machine or by multiple different host machines. The physical host machines may also host virtual host machines, container-based hosts or functions, and the like. The VNICs and VCN VR depicted in FIG. 8 may be executed by the NVDs depicted in FIG. 9. The gateways depicted in FIG. 8 may be executed by the host machines and/or by the NVDs depicted in FIG. 9.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 9, host machines 902 and 908 execute hypervisors 960 and 966, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 9, hypervisor 960 may sit on top of the OS of host machine 902 and enables the computing resources (e.g., processing, memory, and networking resources) of host machine 902 to be shared between compute instances (e.g., virtual machines) executed by host machine 902. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 9 may have the same or different types of hypervisors.

A compute instance can be a virtual machine instance or a bare metal instance. In FIG. 9, compute instances 968 on host machine 902 and 974 on host machine 908 are examples of virtual machine instances. Host machine 906 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 9, host machine 902 executes a virtual machine compute instance 968 that is associated with VNIC 976, and VNIC 976 is executed by NVD 910 connected to host machine 902. As another example, bare metal instance 972 hosted by host machine 906 is associated with VNIC 980 that is executed by NVD 912 connected to host machine 906. As yet another example, VNIC 984 is associated with compute instance 974 executed by host machine 908, and VNIC 984 is executed by NVD 912 connected to host machine 908.

For compute instances hosted by a host machine, an NVD connected to that host machine also executes VCN VRs corresponding to VCNs of which the compute instances are members. For example, in the embodiment depicted in FIG. 9, NVD 910 executes VCN VR 977 corresponding to the VCN of which compute instance 968 is a member. NVD 912 may also execute one or more VCN VRs 983 corresponding to VCNs corresponding to the compute instances hosted by host machines 906 and 908.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 9, host machine 902 is connected to NVD 910 using link 920 that extends between a port 934 provided by a NIC 932 of host machine 902 and between a port 936 of NVD 910. Host machine 906 is connected to NVD 912 using link 924 that extends between a port 946 provided by a NIC 944 of host machine 906 and between a port 948 of NVD 912. Host machine 908 is connected to NVD 912 using link 926 that extends between a port 952 provided by a NIC 950 of host machine 908 and between a port 954 of NVD 912.

The NVDs are in turn connected via communication links to top-of-the-rack (TOR) switches, which are connected to physical network 918 (also referred to as the switch fabric). In certain embodiments, the links between a host machine and an NVD, and between an NVD and a TOR switch are Ethernet links. For example, in FIG. 9, NVDs 910 and 912 are connected to TOR switches 914 and 916, respectively, using links 928 and 930. In certain embodiments, the links 920, 924, 926, 928, and 930 are Ethernet links. The collection of host machines and NVDs that are connected to a TOR is sometimes referred to as a rack.

Physical network 918 provides a communication fabric that enables TOR switches to communicate with each other. A communication fabric, also called network fabric or fabric, refers to a physical network structure that includes a set of interconnected switches that provide multiple redundant pathways for data flow between a set of computing devices. A fabric enables high-throughput, low-latency communication through structured, multi-path routing. A fabric has a topology that defines a physical layout and arrangement of the set of interconnected switches and links. The physical layout and arrangement of the set of interconnected switches and links define pathways for data to flow across the fabric. In an embodiment, physical network 918 can be a multi-tiered network. In certain implementations, physical network 918 is a multi-tiered Clos network of switches, with TOR switches 914 and 916 representing the leaf level nodes of the multi-tiered and multi-node physical switching network 918. Example network fabrics employing different network topologies, such as a Clos topology, are further described below in the Section titled “Example Network Fabrics.”

### 8. EXAMPLE NETWORK FABRICS

Computing components located in the various racks of a data center are interconnected to one another by fabric. The term “network fabric” or “fabric” generally refers to a physical network structure that includes a set of interconnected switches that provide multiple redundant pathways for data flow between a set of computing devices. A fabric enables high-throughput, low-latency communication through structured, multi-path routing.

A fabric is associated with a topology that defines a physical layout and arrangement of the set of interconnected switches and links. The physical layout and arrangement of the set of interconnected switches and links define pathways for data to flow across the fabric. An example network topology is multi-tiered Clos topology. A multi-tiered Clos topology is a type of non-blocking, multistage or multi-tiered switching network topology, where the number of stages or tiers can be two, three, four, five, etc. A Clos network with “n” stages may be referred to as a “n”-tiered network. Each switch in “tier n” is connected to each switch in “tier n+1.” In a 2-tier spine, t1 may be referred to a leaf layer, and t2 may be referred to as a spine layer. The spine layer can server as a high-speed backbone, interacting with the leaf layer.

A fabric can include different groups of switches and clients, referred to as “fabric groups” and “client groups,” arranged in various variations or arrangements of network topologies. Each tier of the fabric includes one or more fabric groups. The leaf tier includes one or more client groups (e.g., computing servers, GPU servers, and/or end devices). A “role” of a fabric group is associated with the tier of the fabric group. For example, a role of a fabric group in t1 may be “leaf”; and a role of a fabric group in t2 may be “spine.”

Each fabric group has a defined number of switches. Each switch has one or more south-facing ports, also called “downlinks,” and one or more north-facing ports, also called “uplinks.” The south-facing ports of switches in a fabric group of an upper tier may be connected to the north-facing ports of switches in a fabric group of a lower tier.

The configuration of connections between switches of fabric groups of adjacent tiers may be referred to as “linking configurations” or “linking rules.” Examples of linking configurations include a full mesh configuration, or a partial mesh configuration. In a full mesh configuration, every south-facing port of switches of an upper fabric group is directly connected to every north-facing port of switches of a lower fabric group. The non-blocking configuration allows connections to be made between switches in adjacent tiers without interference from currently established connections. Various cablings options may be used to implement the links, such as Active Optical Connectors (AOCs); high-speed optical transceivers that uses Coarse Wavelength Division Multiplexing (CWDM); and/or high-speed, hot-pluggable, low-power-dissipation optical transceivers.

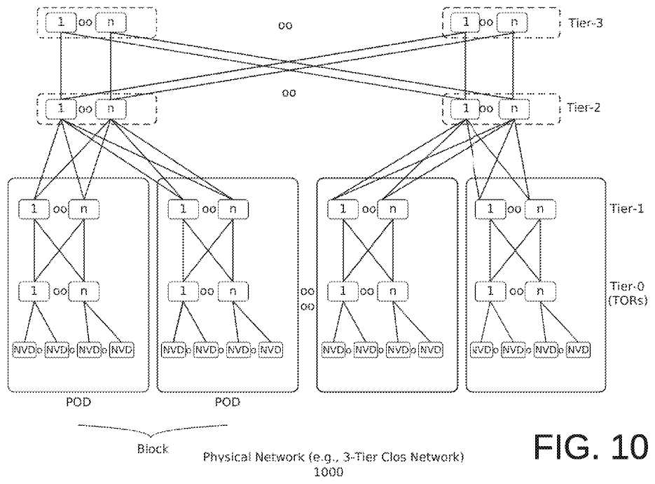

FIG. 10 depicts a simplified block diagram of a physical network 1000 structured as a Clos network according to certain embodiments. The embodiment depicted in FIG. 10 is a 3-tiered network comprising tiers 1, 2, and 3. The TOR switches represent Tier-0 switches in the Clos network. One or more NVDs are connected to the TOR switches. Tier-0 switches are also referred to as edge devices of the physical network. The Tier-0 switches are connected to Tier-1 switches (also referred to as leaf switches). In the embodiment depicted in FIG. 10, a set of “n” Tier-0 TOR switches are connected to a set of “n” Tier-1 switches and together form a pod. Each Tier-O switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 800 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In an embodiment, a single site implements multiple networks, each implemented by one or more network fabrics. Each network in a site may serve a different purpose, such as a front-end network, a back-end network, a management network, and/or other networks. Each network fabric in a site may be implemented using a different network topology or a different combination of network topologies.

As examples, a compute network fabric architecture (CNFA) is configured to connect with non-network racks (compute, storage, service enclave, etc.) within a datacenter. CNFA may be implemented as a 3-tier Clos network. A junction network fabric architecture (JNFA) is configured to connect with network device roles, including: CNFAs; internet gateways; dedicated private connections to on-premise datacenters of customers; and backbone devices. JNFA may be implemented as a 2-tier Clos network. A management network fabric architecture (MNFA) is configured to connect with management devices. In an example, a site includes a CNFA, JNDA, and MNFA. The CNFA may include multiple (e.g., six) blocks. For external connectivity, a subset of t2 blocks (e.g., one t2 block) of the CNFA in a site is dedicated to connecting to t1 switches of the JNFA (rather than t3 super-spine switches of the CNFA, as described above). Further, one or more t1 switches of the JNFA are dedicated to connecting to t1 switches of the MNFA.

As further examples, performance network fabric architectures (PNFA) may be used. PNFA provides connectivity for cluster networks, such as high-performance computer (HPC) networks, high-performance database platform networks, and GPU networks. PNFA enables fine-grained traffic engineering that supports Quality of Service (QoS), which is a set of technologies that manage network traffic to prioritize critical applications. PNFA supports RDMA over Converged Ethernet (e.g., RoCE v1 and/or ROCEv2), Virtual extensible Local-Area Network (VXLAN), dynamic load balancing (DLB), Dot1x, etc. Different variants of PNFA have different numbers of tiers, e.g., two, three. In an example, a site may include a CNFA and a PNFA. “RDMA” or “Remote Direct Memory Access” generally refers to a technology that allows computing devices to access each other's memory directly without using the operating system.

A fabric topology is implemented by physical racks of switches. In an embodiment, each block of switches in a network fabric is implemented in separate racks within a datacenter. FIG. 11 depicts a data hall 1100 including rows of compute racks and network racks, with the network racks implementing a network fabric, according to certain embodiments. The leaf block racks 1101 may be located on the data hall floor adjacent to host-containing racks 1102, effectively providing the data hall with functionality of an intermediate distribution frame (IDF). The spine block racks 1103 may be located in a network row 1104 in the data hall 1100, effectively providing the data hall with functionality of a main distribution frame (MDF). Several data halls can be combined to provide a data center with a larger capacity.

### 9. HARDWARE OVERVIEW

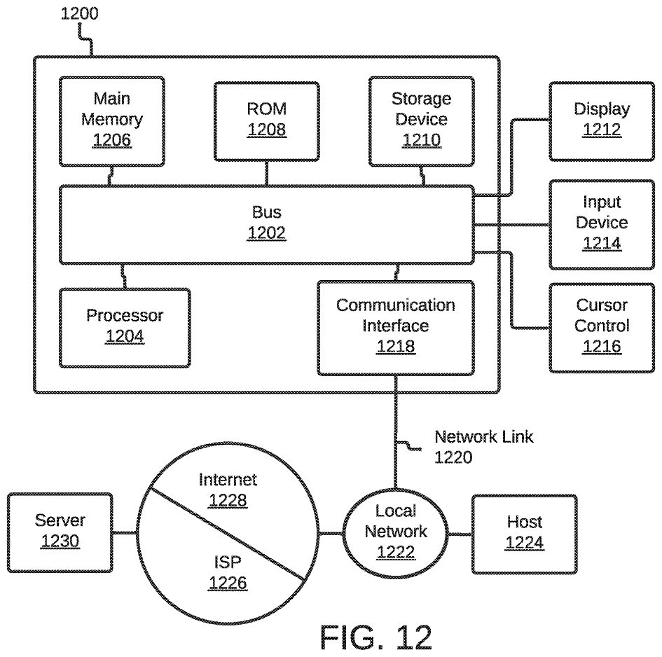

FIG. 12 illustrates an example computer system 1200. An embodiment of the disclosure may be implemented upon the computer system 1200. As shown in FIG. 12, computer system 1200 includes a processing unit 1204 that communicates with peripheral subsystems via a bus subsystem 1202. These peripheral subsystems may include a processing acceleration unit 1206, an I/O subsystem 1208, a storage subsystem 1218, and a communications subsystem 1224. Storage subsystem 1218 includes tangible computer-readable storage media 1222, computer-readable storage reader 1220 and a system memory 1210.

Bus subsystem 1202 provides a mechanism for letting the various components and subsystems of computer system 1200 to communicate with other components and subsystems as intended. Although bus subsystem 1202 is shown schematically as a single bus, alternative embodiments of the bus subsystem may utilize multiple buses. Bus subsystem 1202 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1386.1 standard.

Processing unit 1204 controls the operation of computer system 1200. Processing unit 1204 can be implemented as one or more integrated circuits (e.g., a conventional microprocessor or microcontroller). One or more processors may be implemented in processing unit 1204. These processors may include single core or multicore processors. In certain embodiments, processing unit 1204 may be implemented as one or more independent sub processing units 1232 and/or 1234 with single or multicore processors implemented in one or more processing units. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, the program code to be executed can be wholly or partially implemented in processing unit 1204 and/or in storage subsystem 1218. Through suitable programming, processing unit 1204 can provide various functionalities described above. Computer system 1200 may additionally include a processing acceleration unit 1206 that can include a digital signal processor (DSP), a special-purpose processor, and/or the like.

I/O subsystem 1208 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 360 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 1200 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 1200 may comprise a storage subsystem 1218 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 1204, provide the functionality described above. Storage subsystem 1218 may also provide a repository for storing data used in accordance with the present disclosure.

As depicted in the example in FIG. 12, storage subsystem 1218 can include various components, including a system memory 1210, computer-readable storage media 1222, and a computer readable storage media reader 1220. System memory 1210 may store program instructions, such as application programs 1212, that are loadable and executable by processing unit 1204. System memory 1210 may also store data, such as program data 1214, that is used during the execution of the instructions and/or data that is generated during the execution of the program instructions. Various programs may be loaded into system memory 1210 including, but not limited to, client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 1210 may include a basic input/output system (BIOS) including basic routines that help to transfer information between elements within computer system 1200 such as during start-up.

Computer-readable storage media 1222 may represent remote, local, fixed, and/or removable storage devices plus storage media for temporarily and/or more permanently including and storing computer-readable information for use by computer system 1200, including instructions executable by processing unit 1204 of computer system 1200.

Computer-readable storage media 1222 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 1200.

Machine-readable instructions executable by one or more processors or cores of processing unit 1204 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments, communications subsystem 1224 can include radio frequency (RF) transceiver components to access wireless voice and/or data networks (e.g., using cellular telephone technology, advanced data network technology, such as 3G, 4G, or EDGE (enhanced data rates for global evolution), WiFi (IEEE 602.11 family standards, or other mobile communication technologies, or any combination thereof), global positioning system (GPS) receiver components, and/or other components. In some embodiments, communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 1224 may be configured to receive data in the form of continuous data streams. The continuous data streams may include event streams 1228 of real-time events and/or event updates 1230 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in FIG. 12 is intended as a non-limiting example. Many other configurations having more or fewer components than the system depicted in FIG. 12 are possible. For example, customized hardware might also be used and/or particular elements might be implemented in hardware, firmware, software (including applets), or a combination. Furthermore, connection to other computing devices, such as network input/output devices, may be employed. Based on the disclosure and teachings provided herein, a person of ordinary skill in the art will appreciate other ways and/or methods to implement the various embodiments.

### 10. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

### 10. MISCELLANEOUS; EXTENSIONS

Unless otherwise defined, terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected and efforts made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions, that when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application in the specific form in which such claims issue, including any subsequent correction.

What is claimed is:

1. A method comprising:
routing, through a first facility network, a first signal indicating a first physical condition in a first physical environment from a first controller to a first interface of a first communication channel, wherein the first facility network is local to the first physical environment;
routing, through a cloud network, the first signal from a second interface of the first communication channel to a supervisory control and data acquisition (SCADA) service;
processing, by the SCADA service, the first signal to generate a second signal indicating a control response;
routing, through the cloud network, the second signal from the SCADA service to the second interface of the first communication channel; and
routing, through the first facility network, the second signal from the first interface of the first communication channel to a second controller, wherein each of the cloud network and the first facility network is a separate network and wherein the method is performed by at least one device including a hardware processor.

2. The method of claim 1, wherein the first physical condition is associated with at least one of a component of a liquid cooling system, a component of an air-cooling system, a component of a power distribution system, or a component of a physical security system.

3. The method of claim 1, wherein the first signal is generated by the first controller based on the first physical condition detected by a sensor.

4. The method of claim 1, wherein the first communication channel comprises at least one of a dedicated peering connection, or a dedicated physical connection between the first facility network and the cloud network.

5. The method of claim 1, wherein each of the cloud network and the first facility network is a separate physical network, each physical network associated with a separate network fabric.

6. The method of claim 1, wherein the first communication channel enables secure bidirectional communication while maintaining logical separation between the first facility network and the cloud network.

7. The method of claim 1, further comprising:
routing, through a second facility network, a third signal indicating a second physical condition in a second physical environment from a third controller to a third interface of a second communication channel, wherein the second facility network is local to the second physical environment;
routing, through the cloud network, the third signal from a fourth interface of the second communication channel to the SCADA service;
processing, by the SCADA service, the third signal to generate a fourth signal indicating a control response;
routing, through the cloud network, the fourth signal from the SCADA service to the fourth interface of the second communication channel; and
routing, through the second facility network, the fourth signal from the third interface of the second communication channel to a fourth controller, wherein each of the cloud network and the first facility network and the second facility network is a separate network.

8. The method of claim 7, wherein a graphical user interface associated with the SCADA service presents information associated with the first signal indicating the first physical condition in the first physical environment and the third signal indicating the second physical condition in the second physical environment.

9. The method of claim 1, wherein the second controller causes a physical response based on the second signal.

10. The method of claim 9, wherein the physical response is a cooling, power, or physical security response.

11. One or more non-transitory computer readable media comprising instructions which, when executed by one or more hardware processors, cause performance of operations comprising:
routing, through a first facility network, a first signal indicating a first physical condition in a first physical environment from a first controller to a first interface of a first communication channel, wherein the first facility network is local to the first physical environment;
routing, through a cloud network, the first signal from a second interface of the first communication channel to a supervisory control and data acquisition (SCADA) service;
processing, by the SCADA service, the first signal to generate a second signal indicating a control response;
routing, through the cloud network, the second signal from the SCADA service to the second interface of the first communication channel; and
routing, through the first facility network, the second signal from the first interface of the first communication channel to a second controller, wherein each of the cloud network and the first facility network is a separate network.

12. The non-transitory media of claim 11, wherein the first physical condition is associated with at least one of a component of a liquid cooling system, a component of an air-cooling system, a component of a power distribution system, or a component of a physical security system.

13. The non-transitory media of claim 11, wherein the first signal is generated by the first controller based on the first physical condition detected by a sensor.

14. The non-transitory media of claim 11, wherein the first communication channel comprises at least one of a dedicated peering connection, or a dedicated physical connection between the first facility network and the cloud network.

15. The non-transitory media of claim 11, wherein each of the cloud network and the first facility network is a separate physical network, each physical network associated with a separate network fabric.

16. A system comprising:
at least one device including a hardware processor;
the system being configured to perform operations comprising:
routing, through a first facility network, a first signal indicating a first physical condition in a first physical environment from a first controller to a first interface of a first communication channel, wherein the first facility network is local to the first physical environment;
routing, through a cloud network, the first signal from a second interface of the first communication channel to a supervisory control and data acquisition (SCADA) service;
processing, by the SCADA service, the first signal to generate a second signal indicating a control response;
routing, through the cloud network, the second signal from the SCADA service to the second interface of the first communication channel; and
routing, through the first facility network, the second signal from the first interface of the first communication channel to a second controller, wherein each of the cloud network and the first facility network is a separate network.

17. The system of claim 16, wherein the first physical condition is associated with at least one of a component of a liquid cooling system, a component of an air-cooling system, a component of a power distribution system, or a component of a physical security system.

18. The system of claim 16, wherein the first signal is generated by the first controller based on the first physical condition detected by a sensor.

19. The system of claim 16, wherein the first communication channel comprises at least one of a dedicated peering connection, or a dedicated physical connection between the first facility network and the cloud network.

20. The system of claim 16, wherein each of the cloud network and the first facility network is a separate physical network, each physical network associated with a separate network fabric.
